(19) United States
(12) Patent Application Publication
(10) Pub. No.: US 2012/0287104 A1
(43) Pub. Date: Nov. 15, 2012

(54) LIQUID CRYSTAL DISPLAY DEVICE

(75) Inventors: Shohei Katsuta, Osaka-shi (JP); Tsuyoshi Kamada, Osaka-shi (JP); Tetsuya Ide, Osaka-shi (JP); Seiji Ohhashi, Osaka-shi (JP)

(73) Assignee: SHARP KABUSHIKI KAISHA, Osaka-shi, Osaka (JP)

(21) Appl. No.: 13/519,608

(22) PCT Filed: Nov. 1, 2010
(86) PCT No.: PCT/JP2010/069447

§ 371 Date: Jun. 28, 2012

(30) Foreign Application Priority Data
Jan. 7, 2010 (JP) 2010-002303

(51) Int. Cl. G09G 3/36; G09G 5/00

(52) U.S. Cl. 345/211; 345/88

(57) ABSTRACT

A liquid crystal display device (1) includes: a plurality of pixels each displaying any one of mutually different primary colors; a subpixel, provided for each of the plurality of pixels, which has an auxiliary capacitor (Cs1); and a second subpixel, provided for each of the plurality of pixels, which has an auxiliary capacitor (Cs2), the second subpixel having, at a certain grayscale level, a different luminance from the luminance brought about by the first subpixel. The liquid crystal display device (1) further includes: an auxiliary capacitor line (6n) connected commonly to an auxiliary capacitor (Cs1R) in a pixel (8) and an auxiliary capacitor (Cs1G) in another pixel (10); and an auxiliary capacitor line (7n) connected to an auxiliary capacitor (Cs1B) in another pixel (12). The auxiliary capacitor line (6n) is electrically isolated from the auxiliary capacitor line (7n).

### TECHNICAL FIELD

The present invention relates to a liquid crystal display device with improved viewing angle characteristics.

### BACKGROUND ART

Liquid crystal display devices have been recently used in wide range applications, including monitors for television sets and personal computers. These applications require superior viewing angle characteristics such that one can view an image on the display screen from every direction. On a display screen with poor viewing angle characteristics, the luminance difference achieved in an effective drive voltage range is too small when viewed from an oblique direction. This phenomenon is most recognizable in color variation. For example, the display screen appears whitish when viewed from the oblique direction in comparison with when viewed from a front side. The phenomenon is preventable, for example, by the following techniques where a wide viewing angle can be achieved.

Patent Literature 1 discloses a liquid crystal display device with high transmittance capable of achieving little recognizable difference in color between the front side and oblique directions by making the ratio of the voltage applied to a first subpixel electrode connected to a thin film transistor and the voltage applied to a second subpixel electrode capacitively coupled to that first subpixel electrode differ from other such ratios.

Patent Literature 2 discloses a multidomain vertical alignment liquid crystal display device capable of achieving uniform red, green, and blue gamma levels by making the voltage applied to a larger pixel electrode differ from the voltage applied to a smaller pixel electrode and also by adjusting the voltage value applied to a coupling electrode line.

Patent Literature 3 discloses a liquid crystal display device capable of achieving restrained yellow shift when the display screen is viewed at an oblique viewing angle by making the difference between voltages applied across subpicture elements in blue and/or cyan picture elements smaller than that in picture elements for other colors.

### CITATION LIST

### Patent Literature

Patent Literature 1

Japanese Patent Application Publication, Tokukai, No. 2006-48055A (Published Feb. 16, 2006)

Patent Literature 2

Japanese Patent Application Publication, Tokukai, No. 2009-199067A (Published Sep. 3, 2009)

Patent Literature 3

International Application Published under the PCT, No. WO2005/101817 (Published Oct. 27, 2005)

### SUMMARY OF INVENTION

### Technical Problem

The techniques described in Patent Literatures 1 through 3, however, have the following problems.

The technique of Patent Literature 1 eliminates recognizable color difference between a front side and oblique directions by making the ratio of the voltage applied to a first subpixel electrode and the voltage applied to a second subpixel electrode differ from other such ratios. Nevertheless, Patent Literature 1 does not disclose eliminating recognizable color difference between the front side and oblique directions in a liquid crystal display device employing multipixel drive (MPD).

The technique of Patent Literature 2 have uniform red, green, and blue gamma levels by making the voltage applied to a larger pixel electrode differ from the voltage applied to a smaller pixel electrode. Nevertheless, similarly to the method of Patent Literature 1, Patent Literature 2 does not disclose eliminating recognizable color difference between a front side and oblique directions in a liquid crystal display device employing multipixel drive (MPD).

Patent Literature 3 discloses a technique for the MPD liquid crystal display device to address color shift at an oblique viewing angle, resulting in eliminating recognizable color difference between a front side and oblique directions. Nevertheless, The technique has a problem that it offers only small design freedom in its implementation.

In view of these problems, it is an object of the present invention to provide a liquid crystal display device which can afford greater design freedom in reducing color shift at an oblique viewing angle.

### Solution to Problem

A liquid crystal display device in accordance with the present invention is, in order to address the problems, is a liquid crystal display device, employing multipixel drive, comprising:

a plurality of pixels each displaying any one of mutually different primary colors;

a first subpixel, provided for each of the plurality of pixels, which has a first auxiliary capacitor;

a second subpixel, provided for each of the plurality of pixels, which has a second auxiliary capacitor, the second subpixel having, at a certain grayscale level, a different luminance from the first luminance;

a first auxiliary capacitor line connected commonly to a first auxiliary capacitor in a pixel displaying red and to a first auxiliary capacitor in a pixel displaying green; and

a second auxiliary capacitor line connected to at least a first auxiliary capacitor in a pixel displaying blue, the second auxiliary capacitor line being electrically isolated from the first auxiliary capacitor line.

According to the above arrangement, the liquid crystal display device causes, at a certain grayscale level, the luminances brought about by the subpixels to differ from each other. In other words, one of the subpixels is a bright pixel, and the other is a dark pixel. Accordingly, the display characteristics are improved at an oblique viewing angle. Such a luminance difference is achieved by making the voltages applied across the subpixels differ by a specific value.

According to the liquid crystal display device, the first auxiliary capacitor in a pixel displaying blue (blue pixel) and the first auxiliary capacitor in the pixel displaying red or green (red pixel or green pixel) are connected to different auxiliary capacitor lines. Therefore, one can realize, by various techniques, such a design that the difference between the voltages applied across the subpixels in the blue pixel is smaller than the difference between the voltages applied across the subpixels in the red or green pixel.

For example, if the first auxiliary capacitors in all the pixels are designed to have identical capacitances, the amplitude of the voltage applied across the first auxiliary capacitor in the blue pixel may be made smaller than the amplitude of the voltage applied across the first auxiliary capacitor in the red or green pixel. Another feasible design may be to provide a third auxiliary capacitor in the first subpixel constituting the blue pixel and connect the third auxiliary capacitor to the first auxiliary capacitor. This design may be realized by specifying the third auxiliary capacitor to have a capacitance which is smaller than that of the first auxiliary capacitor in the red or green pixel and applying a fixed voltage to the first auxiliary capacitor in the blue pixel.

Any of these techniques makes the difference between the voltages applied across the subpixels in the blue pixel smaller than the difference between the voltages applied across the subpixels in the red or green pixel. This in turn results in reduced color shift at an oblique viewing angle.

As described in the foregoing, the present invention has an effect to provide greater design freedom in reducing color shift at an oblique viewing angle in the liquid crystal display device.

For a fuller understanding of the nature and advantages of the invention, reference should be made to the ensuing detailed description taken in conjunction with the accompanying drawings.

### Advantageous Effects of Invention

The present invention has an effect to provide greater design freedom in reducing color shift at an oblique viewing angle in the liquid crystal display device.

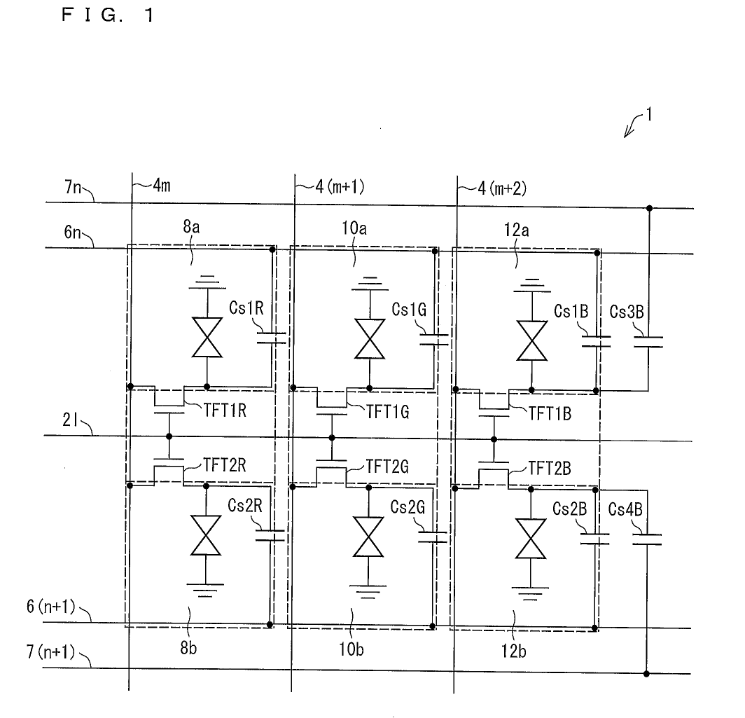

### BRIEF DESCRIPTION OF DRAWINGS

[FIG. 1]

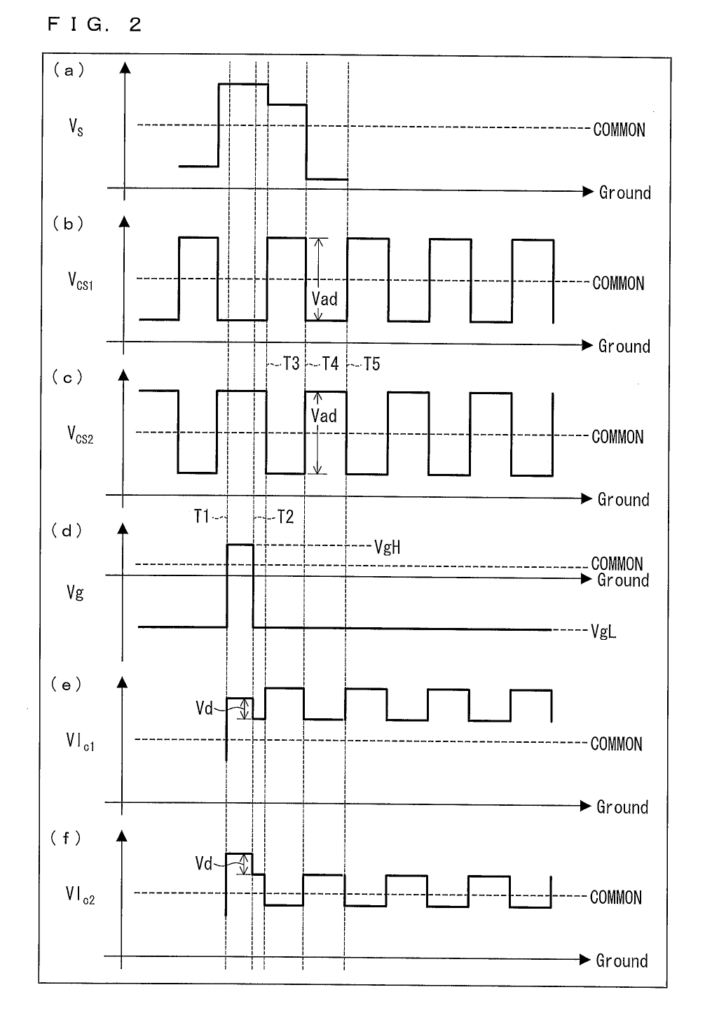

A drawing showing an equivalent circuit of a pixel having a multipixel structure in a liquid crystal display device in accordance with Embodiment 1.

[FIG. 2]

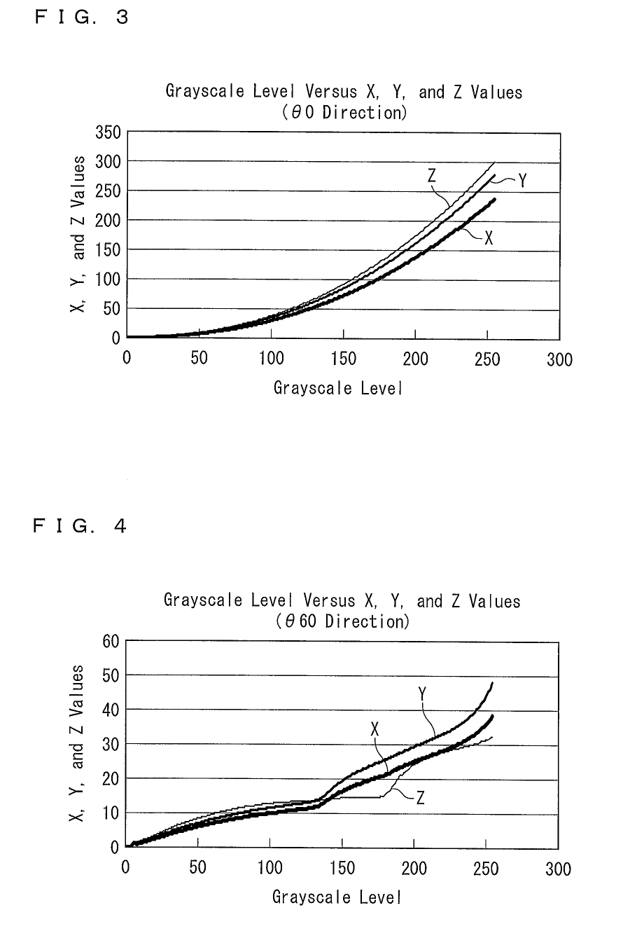

A drawing schematically showing waveforms and timings of respective voltages for driving a liquid crystal display device in accordance with the present invention.

[FIG. 3]

A drawing showing a relationship (characteristics) between respective grayscale levels and respective tristimulus values (X, Y, and Z values) at the front viewing angle.

[FIG. 4]

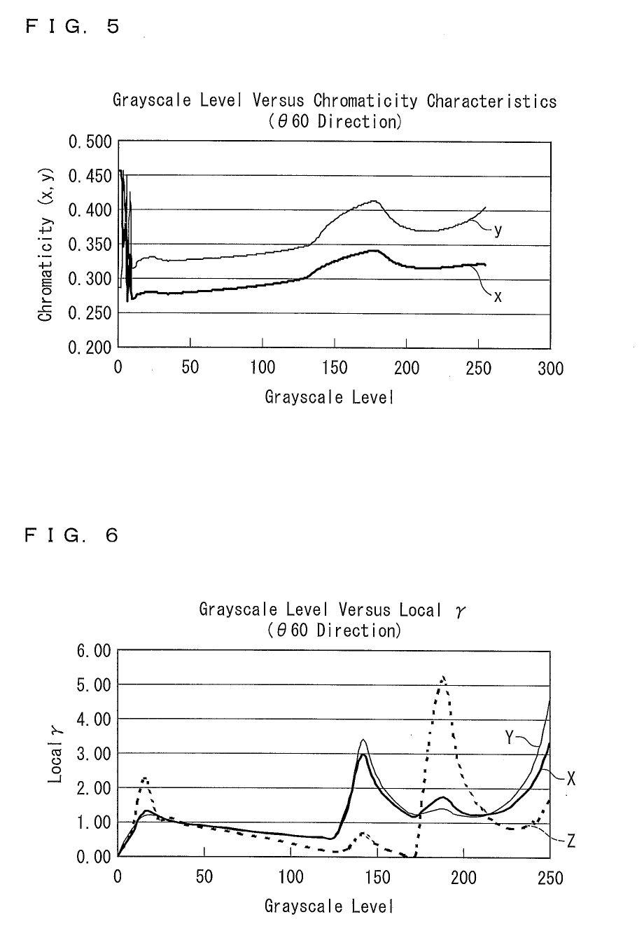

A drawing showing grayscale level versus X, Y, and Z value characteristics obtained at a polar angle of 60° in a liquid crystal display device in accordance with a comparative example.

[FIG. 5]

A drawing showing grayscale level versus x-y value characteristics obtained at a polar angle of 60° in a liquid crystal display device in accordance with a comparative example.

[FIG. 6]

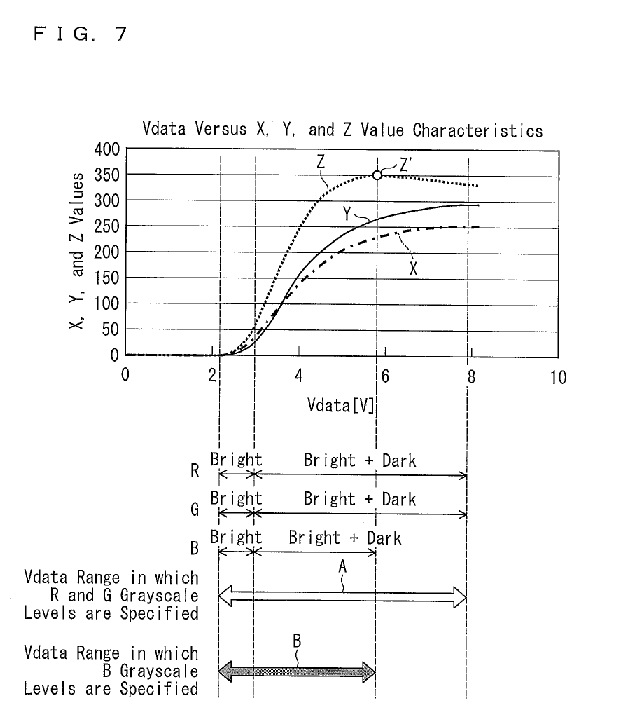

A drawing showing grayscale level versus local γ characteristics obtained at a polar angle of 60° in a liquid crystal display device in accordance with a comparative example.

[FIG. 7]

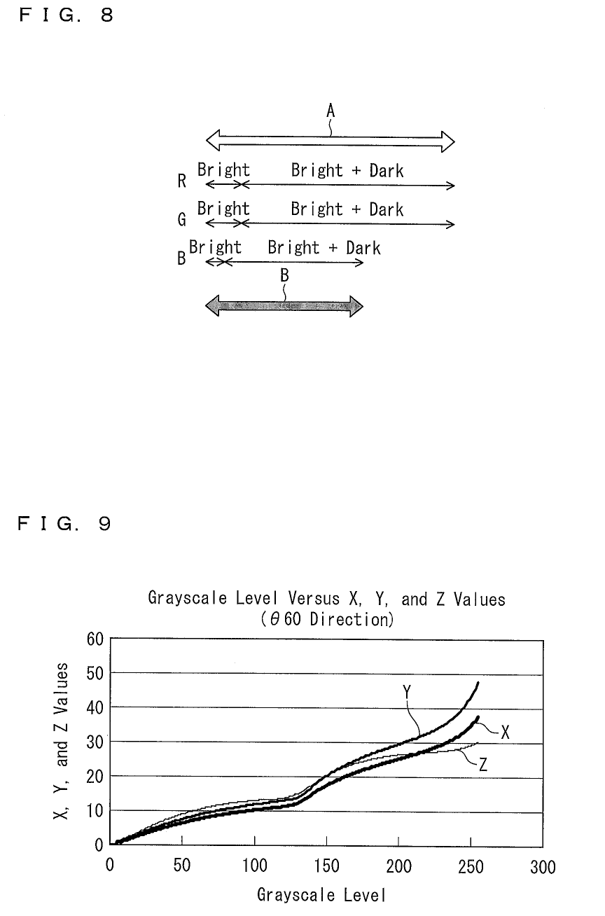

A drawing showing a relationship between respective voltages applied across the liquid crystal layers of each pixel (horizontal axis) and respective X, Y, and Z values (vertical axis).

[FIG. 8]

A drawing illustrating, for each primary color, a grayscale level range in which only bright pixels are lighted and a grayscale level range in which both bright pixels and dark pixels are lighted, in a grayscale level range covering from a minimum grayscale level to a maximum grayscale level, in a liquid crystal display device in accordance with Embodiment 1.

[FIG. 9]

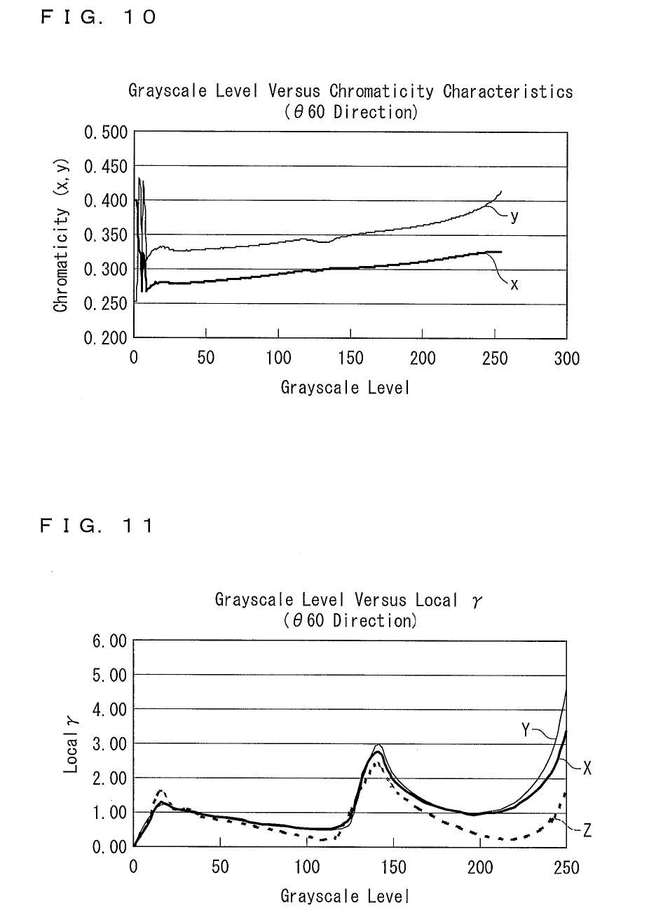

A drawing showing grayscale level versus X, Y, and Z value characteristics obtained at a polar angle of 60° in a liquid crystal display device in accordance with Embodiment 1.

[FIG. 10]

A drawing showing grayscale level versus x-y value characteristics obtained at a polar angle of 60° in a liquid crystal display device in accordance with Embodiment 1.

[FIG. 11]

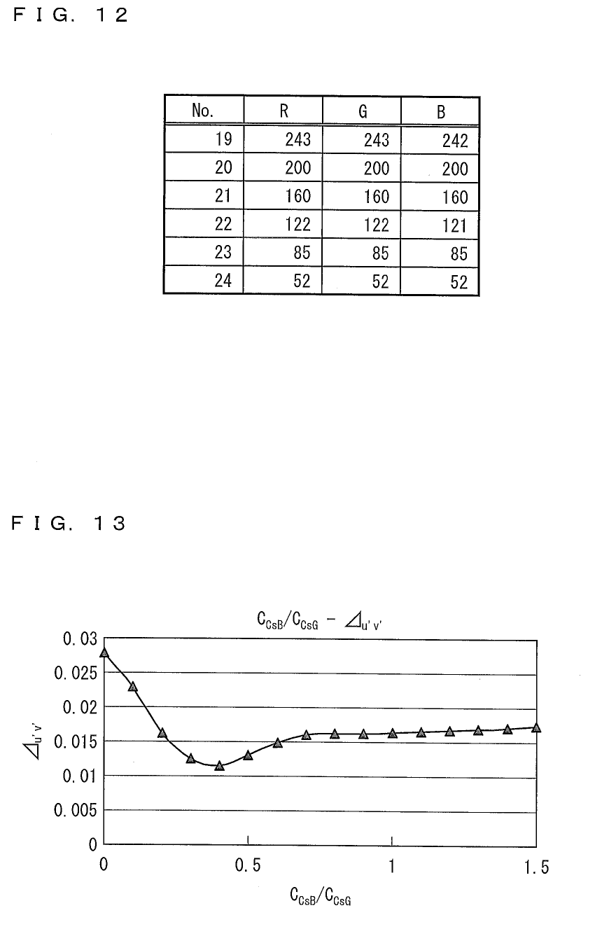

A drawing showing grayscale level versus local γ characteristics obtained at a polar angle of 60° in a liquid crystal display device in accordance with Embodiment 1.

[FIG. 12]

A drawing showing grayscale levels of respective pixels (red (R), green (G), and blue (B)) as to six (No. 19 through 24) out of 24 grayscale colors on the Macbeth chart.

[FIG. 13]

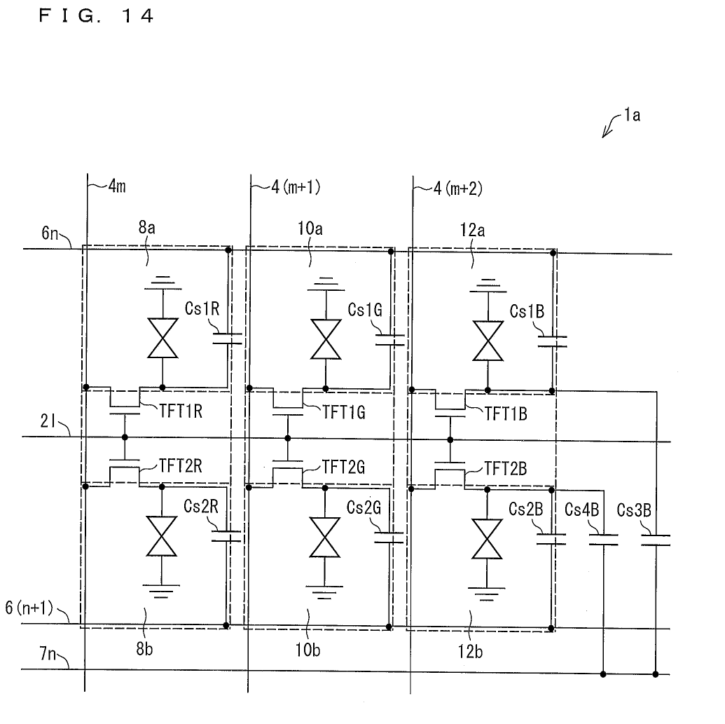

A drawing showing a distance (Δv′v′) between coordinates of u′v′ chromaticity in a front direction and in a polar angle of 60° when the six colors shown in FIG. 12 are displayed.

[FIG. 14]

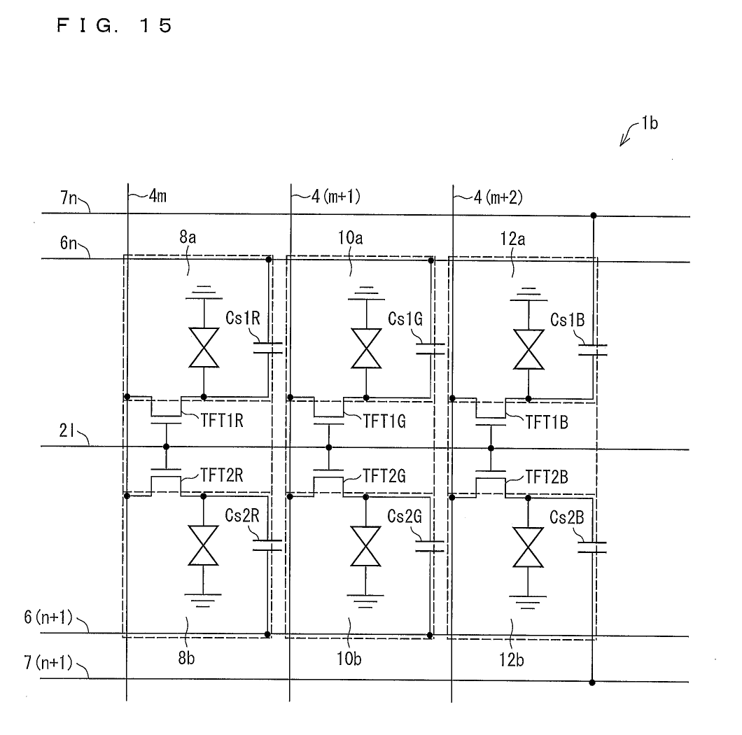

A drawing showing an equivalent circuit of a pixel in a liquid crystal display device in accordance with Embodiment 2.

[FIG. 15]

A drawing showing an equivalent circuit of a pixel in a liquid crystal display device in accordance with Embodiment 3.

[FIG. 16]

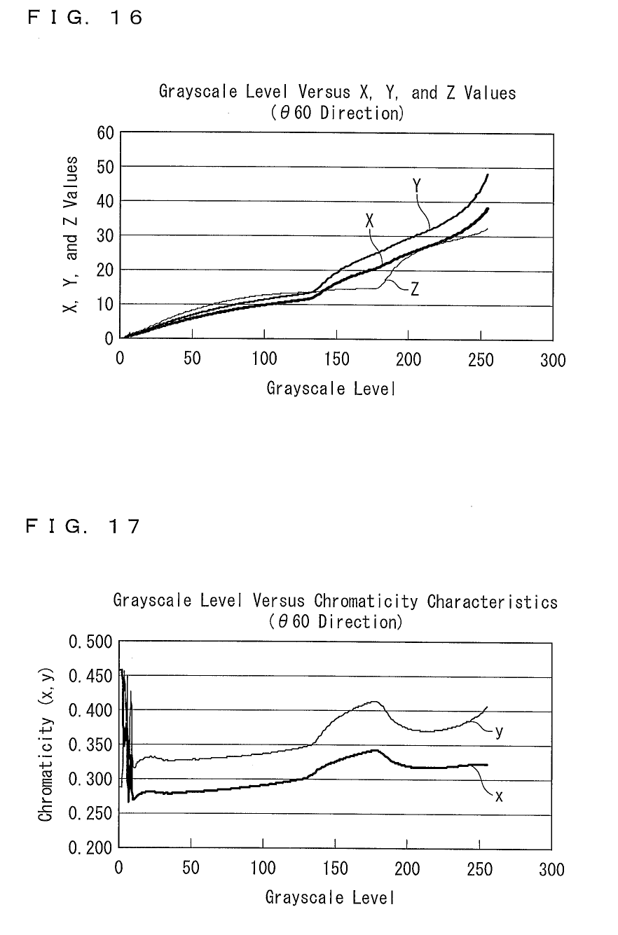

A drawing showing grayscale level versus X, Y, and Z value characteristics obtained at a polar angle of 60° in a liquid crystal display device in accordance with a comparative example.

[FIG. 17]

A drawing showing grayscale level versus x-y value characteristics obtained at a polar angle of 60° in a liquid crystal display device in accordance with a comparative example.

[FIG. 18]

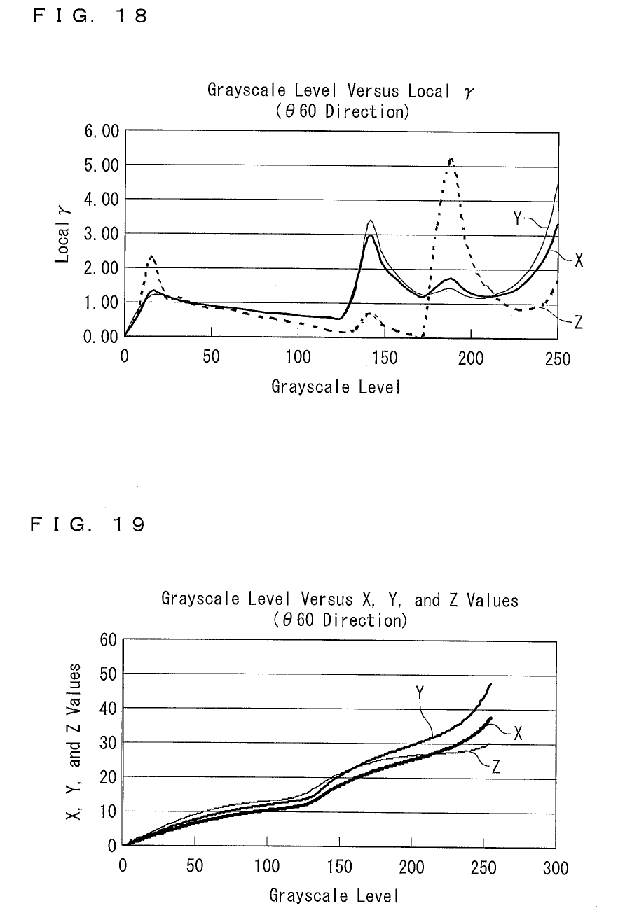

A drawing showing grayscale level versus local γ characteristics obtained at a polar angle of 60° in a liquid crystal display device in accordance with a comparative example.

[FIG. 19]

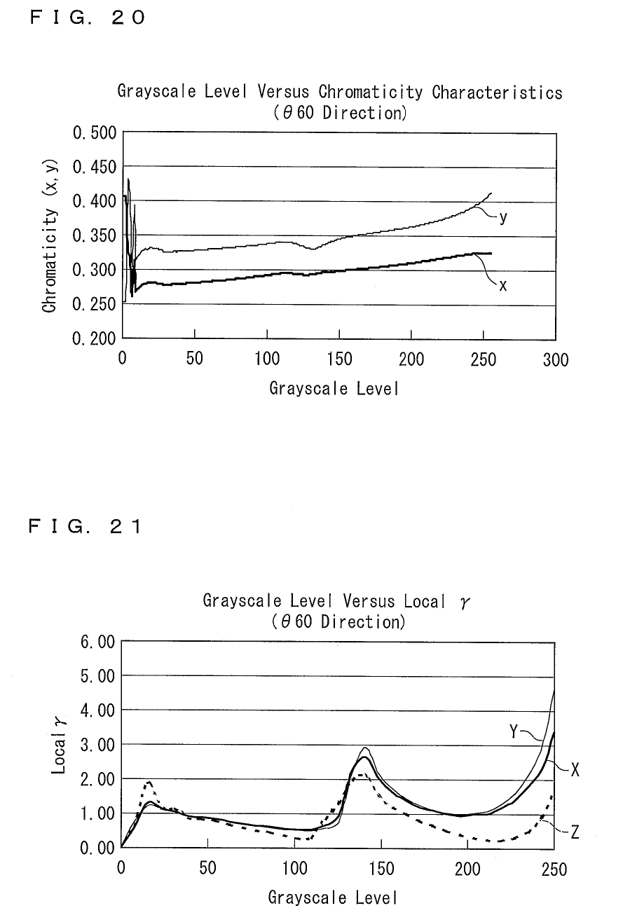

A drawing showing grayscale level versus X, Y, and Z value characteristics obtained at a polar angle of 60° in a liquid crystal display device in accordance with Embodiment 2.

[FIG. 20]

A drawing showing grayscale level versus x-y value characteristics obtained at a polar angle of 60° in a liquid crystal display device in accordance with Embodiment 2.

[FIG. 21]

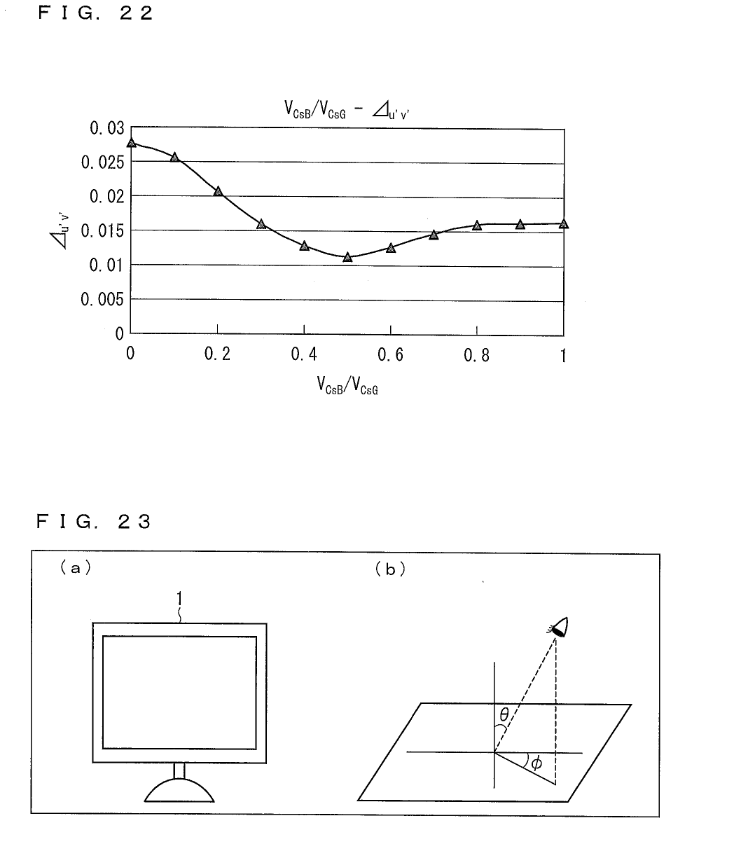

A drawing showing grayscale level versus local γ characteristics obtained at a polar angle of 60° in a liquid crystal display device in accordance with Embodiment 2.

[FIG. 22]

A drawing showing a distance (Δu′v′) between coordinates of u′v′ chromaticity in a front direction and in an oblique direction (60° direction) when the six colors shown in FIG. 12 are displayed on the liquid crystal display device in accordance with Embodiment 2.

[FIG. 23]

A drawing illustrating an overview of a liquid crystal display device in accordance with Embodiment 1.

### DESCRIPTION OF EMBODIMENTS

### Embodiment 1

An embodiment in accordance with the present invention is described below in reference to FIGS. 1 through 13 and FIG. 23. The following description will discuss, as an example, a vertical alignment liquid crystal display device (liquid crystal display device of VA mode) which uses a liquid crystal material with negative dielectric anisotropy and brings about a marked effect of the present invention. The present invention is, however, by no means limited to this. The present invention is applicable, for example, to liquid crystal display devices of TN mode.

### (Structure of Liquid Crystal Display Device 1)

FIG. 1 is a drawing showing an equivalent circuit of a pixel having a multipixel structure in a liquid crystal display device 1 of Embodiment 1. As shown in FIG. 1, the liquid crystal display device 1 includes (i) gate bus lines 2, (ii) source bus lines 4, (iii) switching elements TFT1, (iv) switching elements TFT2, (v) auxiliary capacitors Cs1, (vi) auxiliary capacitors Cs2, (vii) auxiliary capacitors Cs3, (viii) auxiliary capacitors Cs4, (ix) CS bus lines (auxiliary capacitor lines) 6, and (x) CS bus lines 7. The liquid crystal display device 1 is provided with a plurality of pixels and drives them by a multipixel drive method. Each pixel has liquid crystal layers and electrodes via which voltages are applied across the respective liquid crystal layers. The plurality of pixels are arranged in a matrix of rows and columns.

In FIG. 1, a gate bus line 21 represents an 1-th (1 is a positive integer) gate bus line 2. A source bus line 4m represents an m-th (m is a positive integer) source bus line 4m. A CS bus line 6n represents an n-th (n is a positive integer) CS bus line 6. A CS bus line 7n represents an n-th (n is a positive integer) CS bus line 7. The CS bus lines 6n and 7n are electrically isolated from each other.

### (Driver)

The liquid crystal display device 1 is connected to a gate driver for supplying scan signals to the respective gate bus lines 2, a source driver for supplying data signals to the respective source bus lines 4, and a CS driver for supplying (i) auxiliary capacitor drive signals to the respective CS bus lines 6 and (ii) auxiliary capacitor drive signals to the respective CS bus lines 7 (none of the drivers shown). Both the drivers operate in response to control signals supplied from a control circuit (not shown).

### (Structure of Pixels)

The gate bus lines 2 and the source bus lines 4 are provided to intersect each other via an insulating film (not shown). A pixel is formed, in the liquid crystal display device 1, in each region delimited by a corresponding gate bus line 2 and a corresponding source bus line 4. Each pixel displays a corresponding one of different primary colors. In Embodiment 1, the primary colors include red, green, and blue. R pixels 8 for displaying red, G pixels 10 for displaying green, and B pixels 12 for displaying blue are thus provided respectively in the liquid crystal display device 1. Using these pixels in an appropriate combination allows a desired color image to be displayed.

### (Bright Pixels and Dark Pixels)

The R pixels 8, G pixels 10, and B pixels 12 each have two subpixels (a bright pixel and a dark pixel) in which different voltages can be applied across the respective liquid crystal layers. Specifically, the R pixel 8 has a bright pixel 8a and a dark pixel 8b, the G pixel 10 has a bright pixel 10a and a dark pixel 10b, and the B pixel 12 has a bright pixel 12a and a dark pixel 12b.

Each subpixel has a liquid crystal capacitor formed by a counter electrode and a subpixel electrode which faces the counter electrode with the liquid crystal layer interposed therebetween. Furthermore, each subpixel also has at least one auxiliary capacitor formed by an auxiliary capacitor electrode which is electrically connected to the subpixel electrode, an insulating layer, and an auxiliary capacitor counter electrode which faces the auxiliary capacitor electrode with the insulating layer interposed therebetween.

After a display voltage corresponding to a certain grayscale level is supplied to a subpixel electrode of each subpixel, there occurs a specific voltage difference between a voltage applied across the liquid crystal capacitor of the bright pixel via at least one corresponding auxiliary capacitor and a voltage applied across the liquid crystal capacitor of the dark pixel via at least one corresponding auxiliary capacitor. This causes the bright pixel to have a higher luminance than the dark pixel when the display voltage corresponding to the certain grayscale level is applied.

### (Liquid Crystal Capacitor and Auxiliary Capacitor)

Each pixel has a liquid crystal capacitor Clc (not shown). The liquid crystal capacitor Clc is electrically connected in parallel with the first auxiliary capacitor Cs1 and the second auxiliary capacitor Cs2. The auxiliary capacitor Cs1 and the auxiliary capacitor Cs2 are each formed by an insulating film (e.g., gate insulating film) and a counter electrode which faces the auxiliary capacitor electrode with the insulating film interposed therebetween.

According to the R pixel 8, an auxiliary capacitor Cs1R is formed in the bright pixel 8a, and an auxiliary capacitor Cs2R is formed in the dark pixel 8b (see FIG. 1). Similarly, according to the G pixel 10, an auxiliary capacitor Cs1G is formed in the bright pixel 10a, and an auxiliary capacitor Cs2G is formed in the dark pixel 10b. Also, according to the B pixel 12, an auxiliary capacitor Cs1B is formed in the bright pixel 12a, and an auxiliary capacitor Cs2B is formed in the dark pixel 12b.

Hereinafter, the auxiliary capacitor Cs1R and the auxiliary capacitor Cs2R may be collectively referred to as the auxiliary capacitor CsR. Similarly, the auxiliary capacitor Cs1G and the auxiliary capacitor Cs2G may be collectively referred to as the auxiliary capacitor CsG. Also, the auxiliary capacitor Cs1B and the auxiliary capacitor Cs2B may be collectively referred to as the auxiliary capacitor CsB.

An additional auxiliary capacitor Cs3B is formed in the bright pixel 12a of the B pixel 12. Also, an additional auxiliary capacitor Cs4B is formed in the dark pixel 12b of the B pixel 12.

In Embodiment 1, Cs1R=Cs1G=Cs1B+Cs3B (later described in detail). Therefore, Cs1B<Cs1R=Cs1G. Similarly, Cs2R=Cs2G=Cs2B+Cs4B. Thus, Cs2B<Cs2R=Cs2G.

### (Switching Element)

TFT (thin film transistor) 1 and TFT2 are provided in each of the R pixel 8, G pixel 10, and B pixel 12. Each TFT1 is provided in a corresponding bright pixel, and each TFT2 is provided in a corresponding dark pixel. The auxiliary capacitor electrode of each auxiliary capacitor Cs is connected to the drain electrode of a corresponding TFT1 or TFT2. The gate electrodes of TFT1 and TFT2 are connected to a single gate bus line 21, and the source electrodes of TFT1 and TFT2 are connected to a single source bus line 4. Specifically, as shown in FIG. 1, the source electrodes of TFT1R and TFT2R of the R pixels 8 are connected to the source bus line 4m. Similarly, the source electrodes of TFT1G and TFT2G of the G pixel 10 are connected to the source bus line 4(m+1), and the source electrodes of TFT1B and TFT2B of the B pixel 12 are connected to the source bus line 4(m+2).

### (CS Bus Line 6)

Each CS bus line 6 extends parallel to a corresponding gate bus line 2 so as to come across a pixel region delimited by a corresponding gate bus line 2 and a corresponding source bus line 4. Each CS bus line 6 is provided commonly to a corresponding R pixel 8, a corresponding G pixel 10, and a corresponding B pixel 12 which are provided in the same row in the liquid crystal display device 1. Specifically, the CS bus line 6n is connected to Cs1R (first auxiliary capacitor), Cs1G (first auxiliary capacitor), and Cs1B (third auxiliary capacitor). The CS bus line 6(n+1) is connected to Cs2R (second auxiliary capacitor), Cs2G (second auxiliary capacitor), and Cs2B (fourth auxiliary capacitor).

The following description will discuss a method of driving the equivalent circuit of the liquid crystal display device 1 having a multipixel structure in reference to FIG. 2. FIG. 2 is a drawing schematically showing waveforms and timings of respective voltages for driving liquid crystal display device 1.

(a) of FIG. 2 shows a voltage waveform Vs of a signal voltage supplied from the source bus line 4, (b) of FIG. 2 shows a voltage waveform Vcs1 of an auxiliary capacitor voltage supplied from the CS bus line 6, (c) of FIG. 2 shows a voltage waveform Vcs2 on the CS bus line 6, (d) of FIG. 2 shows a voltage waveform Vg on the gate bus line 2, (e) of FIG. 2 shows a voltage waveform Vlc1 on a subpixel electrode of a subpixel (bright pixel), and (f) of FIG. 2 shows a voltage waveform Vlc2 on a subpixel electrode of a subpixel (dark pixel). The broken lines in FIG. 2 represent a voltage waveform COMMON (Vcom) on the counter electrode.

Now, referring to (a) of FIG. 2 through (f) of FIG. 2, it will be described how the equivalent circuit in FIG. 1 operates.

The TFT1 and TFT2 are simultaneously turned on (ON state) in response to a rising edge of the voltage Vg from VgL (LOW) to VgH (HIGH) at time T1. This causes the voltage Vs on a source bus line 4 to be transmitted to the subpixel electrodes of the respective bright and dark pixels. The bright and dark pixels are ultimately charged by the voltage Vs. Similarly, the auxiliary capacitors Cs1 and Cs2 of the respective subpixels are charged by the voltage Vs on the source bus line 4. The voltage Vs on the source bus line 4 is a display voltage corresponding to a grayscale level to be displayed by a corresponding pixel, and is written to the corresponding pixel while the TFT is in an ON state (may be referred to as a “selection period”).

Subsequently, the TFT1 and TFT2 are simultaneously turned off (OFF state) in response to a falling edge of the voltage Vg on the gate bus line 2 from VgH to VgL at time T2. This causes all of the bright pixel, the dark pixel, the auxiliary capacitor Cs1, and the auxiliary capacitor Cs2 to be electrically insulated from the source bus line 4 (the period in which this state exists may be referred to as a “non-selection period”). Note that immediately after the switching of the TFT from the ON state to the OFF state, the voltages Vlc1 and Vlc2 on the respective subpixel electrodes are decreased by a substantially equal voltage Vd due to a feed-through phenomenon caused by parasitic capacitances of TFT1 and TFT2, respectively. The voltages Vlc1 and Vlc2 in this state are expressed as follows:

Vlc1=Vs−ΔVd

Vlc2=Vs−ΔVd

The voltages Vcs1 and Vcs2 on the CS bus lines 6 are expressed as follows:

Vcs1=Vcom−(½)Vad

Vcs2=Vcom−(½)Vad

In other words, exemplified waveforms of the respective voltages Vcs1 and Vcs2 on the CS bus lines 6 are rectangular pulse voltages with (i) identical amplitudes (peak-to-peak) of Vad, (ii) reversed phases (phase difference of 180°), and (iii) duty ratio of 1:1.

At time T3, the voltage Vcs1 on the CS bus line 6n connected to the auxiliary capacitor Cs1 changes by Vad, from Vcom−(½)Vad to Vcom+(½)Vad, and the voltage Vcs2 on the CS bus line 6(n+1) connected to the auxiliary capacitor Cs2 changes by Vad, from Vcom+(½)Vad to Vcom−(½)Vad. In response to the changes of the voltages on the respective CS bus lines 6n and 6(n+1), the voltages Vlc1 and Vlc2 on the respective subpixel electrodes change as follows.

Vlc1=Vs−ΔVd+K×Vad

Vlc2=Vs=ΔVd−K×Vad

Note that K=Ccs/(Clc(V)+Ccs).

At time T4, Vcs1 changes by Vad, from Vcom+(½)Vad to Vcom−(½)Vad, and Vcs2 changes by Vad, from Vcom−(½)Vad to Vcom+(½)Vad. Also, Vlc1 and Vcs2 change respectively from

Vlc1=Vs−ΔVd+K×Vad, and

Vlc2=Vs−ΔVd−K×Vad

to

Vlc1=Vs−ΔVd, and

Vlc2=Vs−ΔVd.

At time T5, Vcs1 changes by Vad, from Vcom−(½)Vad to Vcom+(½)Vad, and Vcs2 changes by Vad, from Vcom+(½)Vad to Vcom−(½)Vad. Also, Vlc1 and Vcs2 change respectively from

Vlc1=Vs−ΔVd

Vlc2=Vs−ΔVd

to

Vlc1=Vs−ΔVd+K×Vad

Vlc2=Vs−ΔVd−K×Vad.

As to the Vcs1, Vcs2, Vlc1, and Vlc2, it is possible to set intervals at which the times T4 and T5 are repeated to 1H, twice 1H, triple 1H, or even greater, at intervals of integral multiple of horizontal write period 1H, depending on a driving method (e.g., reverse polarity driving) or a display state (e.g., flickering and grainy appearance of the display) of a liquid crystal display device. The repetition is continued until the pixels are rewritten next time, in other words, until a time equivalent to T1. Therefore, the effective voltages of the voltages Vlc1 and Vlc2 on the subpixel electrodes are expressed as follows:

Vlc1=Vs−ΔVd+K×(½)Vad

Vlc2=Vs−ΔVd+K×(½)Vad

Thus, the effective voltages V1 and V2 applied across the liquid crystal layers of the respective bright and dark pixels are expressed as follows:

V1=Vlc1−Vcom

V2=Vlc2−Vcom

Hence,

V1=Vs−ΔVd+K×(½)Vad−Vcom

V2=Vs−ΔVd−K×(½)Vad−Vcom

Therefore, a difference ΔV12 (=V1−V2; may alternatively referred to as ΔVα) between the effective voltages V1 and V2 applied across the liquid crystal layers of the respective bright and dark pixels is expressed as follows:

ΔV12=K×Vad

where K=Ccs/(Clc+Ccs) and the fact that Clc depends on a voltage is neglected.

Bright pixels and dark pixels are thus formed in the respective pixels.

Voltages are applied across the liquid crystal layers of the respective pixels so that (i) only the bright pixels 8a, 10a, and 12a are substantially lighted at low grayscale levels and (ii) luminances of the respective dark pixels 8b, 10b, and 12b start to rise at a certain intermediate grayscale level or a higher grayscale level. Identical voltages are applied across the bright pixels 8a, 10a, and 12a through the CS bus line 6n. Similarly, identical voltages are applied across the dark pixels 8b, 10b, and 12b through the CS bus line 6(n+1).

### (CS Bus Line 7)

The CS bus lines 7 extend parallel to the CS bus lines 6 and are provided exclusively for the respective B pixels 12. A driver (not shown) applies a fixed voltage to the auxiliary capacitors of the B pixels 12 through the respective CS bus lines 7 (later described in detail). The CS bus line 7n is connected to the auxiliary capacitor (first auxiliary capacitor) Cs3B in the bright pixel 12a. The CS bus line 7(n+1) is connected to the auxiliary capacitor (second auxiliary capacitor) Cs4B in the dark pixel 12b.

A conventional liquid crystal display device has a problem that a color shift occurs in a display image in a case where a display screen is viewed from an oblique direction, unlike a case where the display screen is viewed from its front side (later described in detail) for the reasons described below.

### (XYZ Color System)

A color system, a system for quantitatively representing colors, is first described. A typical color system is the RGB color system using three primary colors: red (R), green (G), and blue (B). The RGB color system, however, falls short of completely representing all perceivable colors. For example, a color of a single wavelength, such as a color of a laser beam, is not covered by the RGB color system. If the coefficients of the RGB values include negative coefficients, then the RGB color system will be able to represent any color. This will, however, cause inconvenience in handling. In view of the circumstances, the XYZ color system, which is an improved version of the RGB color system, is commonly used.

In the XYZ color system, a desired color is represented by a combination of tristimulus values (X value, Y value, and Z value). The new stimulus values, X value, Y value, and Z value, are obtained by adding original R, G, and B values with each other. Such a combination of the tristimulus values allows a representation of all colors, such as a particular spectral color, mixed light of particular spectral colors, and an object color.

Out of the X, Y, and Z values, it is the Y value that corresponds to a brightness stimulus. In other words, the Y value can be used as a typical value of brightness. The X value is a stimulus value primarily representing red, but also includes a certain amount of color stimulus in the blue wavelength region. The Z value is a color stimulus primarily representing blue.

(A View from the Front Side)

Generally, a liquid crystal display device is adjusted so that a display screen can have constant chromaticity at a front viewing angle (0° direction). FIG. 3 is a drawing showing a relationship (characteristics) between respective grayscale levels and respective tristimulus values (X, Y, and Z values) at the front viewing angle. As shown in FIG. 3, a relationship between the respective grayscale levels and respective X, Y, and Z values at the front viewing angle is indicated by a curve with a y (gamma) level of about 2.2. Therefore, no color shift problems will occur when the display screen of the liquid crystal display device is viewed from the front side.

(Observation from Oblique Direction)

Meanwhile, a liquid crystal display device of VA mode has transmittance which varies with a wavelength of light. This is based on the fact that, since the liquid crystal display device of VA mode makes use of a birefringence effect of the liquid crystal layer, retardation of the liquid crystal layer exhibits a wavelength dispersion. In addition, since the retardation of the liquid crystal layer is apparently greater at an oblique viewing angle than at the front viewing angle, the optical wavelength dependence of a variation in transmittance increases at an oblique viewing angle rather than at the front viewing angle. This causes a problem that a color shift occurs when the display screen is viewed from the oblique direction.

The following description will discuss an angle at which the display screen of the liquid crystal display device 1 is viewed from the oblique direction, in reference to FIG. 23. FIG. 23 is a drawing illustrating an overview of the liquid crystal display device 1 in accordance with Embodiment 1. (a) of FIG. 23 shows an overview of the liquid crystal display device 1, and (b) of FIG. 23 shows a polar angle θ and an azimuth φ with respect to the display screen of the liquid crystal display device 1. As shown in (b) of FIG. 23, the polar angle θ is an angle between a viewing direction and a direction in which a normal line, through the center of the display screen, extends. The azimuth angle is an angle between (i) a direction in which a lateral line, through the center of the display screen, extends on the display screen (the direction coincides with the horizontal direction in a situation where the device 1 is placed normally) and (ii) an orthogonal projection of a line of vision onto the display screen.

### (X, Y, and Z Value Characteristics)

FIG. 4 is a drawing showing grayscale level versus X, Y, and Z value characteristics obtained at an oblique viewing angle (i.e., a polar angle of 60°) in a comparative example of the liquid crystal display device 1. The comparative example meets conditions in which a voltage (Vdata) supplied via the source bus lines is 7.60 V, each liquid crystal capacitance of the bright pixels 8a, 10a, and 12a and the dark pixels 8b, 10b, and 12b is 300 fF, the auxiliary capacitors CsR, CsG, and CsB have respective capacitances of 150 fF, and an amplitude of the common voltage is 3 V. Therefore, CsR=CsG=CsB.

As shown in FIG. 4, in a case where the polar angle is 60°, the grayscale level versus X value curve is similar to the grayscale level versus Y value curve. However, the grayscale level versus Z value curve, especially at an intermediate grayscale level, is below the X and Y value curves. The Z value is color stimulus primarily representing blue as described earlier. As such, in a case where a particular color is to be displayed at an intermediate grayscale level, a blue color which is lighter than the blue corresponding to an intended grayscale level is displayed at the 60° polar angle. Specifically, since a blue component of an image to be displayed decreases, the image looks like a yellowish one. This leads to a deterioration in color tone of viewing angle characteristic.

### (Chromaticity Characteristics)

FIG. 5 is a drawing showing grayscale level versus x-y value characteristics, obtained at the polar angle of 60°, of a comparative example of the liquid crystal display device 1. The x and y values are chromaticity coordinates used in an xyY color system which is a new color system based on the XYZ color system. The following relationships are satisfied.

x=X/(X+Y+Z)

y=Y/(X+Y+Z)

As shown in FIG. 5, each of the x and y values exhibits a degree, of a change in chromaticity to a change in grayscale level, which occurs at an intermediate grayscale level (ranging from a grayscale level 120 to a grayscale level 200), deviates from a degree, of a change in chromaticity to a change in grayscale level, which occurs at another gray scale level. As is also clear from FIG. 5, a color shift occurs.

### (Local γ Characteristics)

FIG. 6 is a drawing showing grayscale level versus local y characteristics, obtained at the polar angle of 60°, of a comparative example of the liquid crystal display device 1. The local γ is a value representing a local slope of luminance. The local γ level is calculated from equation (1) below, where T indicates a maximum luminance of the optical characteristics measured at a predetermined angle with respect to a direction in which a nominal line of a display screen extends, Ta indicates a luminance corresponding to a grayscale level “a” in a direction identical to a direction specified by the predetermined angle, and Tb indicates a luminance corresponding to a grayscale level “b” (which differs from “a”).

$$\begin{matrix}[ Math 1 ] & \\ local γ = \frac{log ( {T}_{a} ) - log ( {T}_{b} )}{log ( a ) - log ( b )} & ( 1 )\end{matrix}$$

The γ level increases as a difference between the luminance Ta and Tb increases which correspond to the respective grayscale levels “a” and “b”. Therefore, it is possible to reduce a change in color of a display screen which change is caused when such a difference in luminance becomes small, by making the γ level relatively larger in an oblique direction. Ideally, the liquid crystal display device 1 has viewing angle characteristics in which a γ level is a level (for example, 2.2), over the whole grayscale level range (grayscale levels 0 to 255), which level is identical to a γ level obtained when the display screen is viewed from the front side of the liquid crystal display device 1.

The example in FIG. 6 demonstrates that the local y of the X value and the local γ of the Y value have respective peaks at identical grayscale levels, specifically, at around grayscale level 140. In contrast, the local γ of the Z value has a peak which deviates from the peaks of the local y of the X value and the local γ of the Y value, specifically, at around grayscale level 170. Since the peak of the local γ of the Z value thus deviates from those of the X and Y values, an image to be displayed becomes yellowish at an intermediate grayscale level in a case where the display screen is viewed from an oblique direction.

### (Causes for Poor Viewing Angle Characteristics)

As has been described in reference to FIGS. 4 through 6, the comparative example of the liquid crystal display device 1 has the problem that there occurs a reduction in viewing angle characteristics at an oblique viewing angle (i.e., at a polar angle of 60°). Causes for such a reduction will be described below in detail in reference to FIG. 7.

As described above, each of the R pixel 8, the G pixel 10, and the B pixel 12 has a bright pixel and a dark pixel. According to the liquid crystal display device 1, the viewing angle characteristics obtained at an oblique viewing angle are typically improved, by causing the voltages applied across the liquid crystal layers of the respective bright and dark pixels, i.e., the voltages applied via the CS bus line 6n and the CS bus line 6(n+1), to differ from each other. In other words, the viewing angle characteristics are improved, as described above, by applying voltages across the liquid crystal layers of the respective pixels so that practically, only the bright pixels 8a, 10a, and 12a are lighted at low grayscale levels, and the dark pixels 8b, 10b, and 12b start to light at a certain intermediate grayscale level as well as higher grayscale levels.

FIG. 7 is a drawing showing a relationship between respective voltages applied across the liquid crystal layers of each pixel (horizontal axis) and respective X, Y, and Z values (vertical axis). As shown in FIG. 7, typically, only the Z value representing blue falls when an applied voltage is above a certain value (about 6 V in FIG. 7).

According to the liquid crystal display device 1, voltages applied across the pixels are predetermined for respective grayscale levels in a particular range of grayscale levels (e.g., grayscale levels 0 to 255). In so doing, a voltage range is usually predetermined whose lower limit is a minimum voltage which, if ever, causes, over the entire grayscale level range, an increase in pixel transmittance in response to an applied voltage and whose upper limit is a voltage which causes, over the entire grayscale level range, an increase in pixel transmittance up to a maximum transmittance (saturation transmittance) in response to an applied voltage. Such a voltage range is predetermined for each of the pixel colors (red, green, and blue in Embodiment 1).

In the example in FIG. 7, the X and Y values have respective curve characteristics in which the X and Y values gradually increase in a range from about 2 V to about 8 V so as to have their respective gamma characteristics of 2.2. In view of the curve characteristics, about 2 V is allocated to a grayscale level 0 of each of red and green, and about 8 V is allocated to a grayscale level 255 of each of red and green. Voltages between about 2 V and about 8 V are allocated to the other grayscale levels in accordance with the respective grayscale levels.

In contrast, the Z value has a curve characteristic in which the Z value reaches a maximum value at about 6 V. In view of the curve characteristics, about 2 V is allocated to a grayscale level 0 of blue, and about 6 V is allocated to a grayscale level 255 of blue. Voltages between about 2 V and about 6 V are allocated to the other grayscale levels in accordance with the respective grayscale levels.

The voltage range allocated to the grayscale levels of red and green (arrow A) thus differs from the voltage range allocated to grayscale levels of blue (arrow B). Note that the voltage range allocated only to the bright pixels does not vary from pixel display color to pixel display color. In other words, the voltage range in which only the bright pixels 8a, 10a, and 12a are lighted does not vary, whereas the voltage range in which both the bright pixels 8a, 10a, and 12a and the dark pixels 8b, 10b, and 12b are lighted differ from pixel to pixel. Specifically, the voltage range in which the dark pixel 12b of the B pixel 12 is lighted is solely narrower than the others. As a result, the peak of the local y of the Z value deviates from those of the X and Y values. This causes the characteristics shown in FIGS. 4 through 6, which ultimately causes a color shift to occur at an oblique viewing angle.

To address the problem that the color shift occurs at an oblique viewing angle, the liquid crystal display device 1 of Embodiment 1 is designed so that Cs1B<Cs1R=Cs1G and Cs2B<Cs2R=Cs2G. The following description will discuss why the problem that the color shift occurs can be addressed by the design.

### (Adjustment of Grayscale Level Range)

FIG. 8 is a drawing illustrating, for each primary color, a voltage range in which only bright pixels are lighted and a voltage range in which both bright pixels and dark pixels are lighted, over the entire voltage range covering from a minimum grayscale level to a maximum grayscale level, in the liquid crystal display device 1 of Embodiment 1.

As shown in FIG. 8, according to the liquid crystal display device 1 of Embodiment 1, (i) the original entire voltage range, in which the bright pixel 12a of the B pixel 12 is lighted, is maintained as it is and (ii) the voltage range in which only the bright pixel 12a is lighted is (a) made narrower than the voltage range in which only the bright pixel 8a of the R pixel 8 is lighted and (b) made narrower than the voltage range in which only the bright pixel 10a of the G pixel 10 is lighted. More specifically, over the entire voltage range covering from a minimum grayscale level to a maximum grayscale level, the R pixel 8, the G pixel 10, and the B pixel 12 have identical ratios of (i) the voltage range in which only the bright pixel is lighted and (ii) the voltage range in which both the bright and dark pixels are lighted. As a result, the applied voltages for the respective grayscale levels are designed so that the R pixel 8, the G pixel 10, and the B pixel 12 have identical ratios of (i) the grayscale level range in which only the bright pixel is lighted and (ii) the grayscale level range in which both the bright and dark pixels are lighted. The design enables the peak of the local y of the Z value to coincide with those of the X and Y values. Consequently, no color shift occurs when the screen is viewed from the oblique direction.

### (Adjustment of ΔVα)

In order to allocate the voltages shown in FIG. 8, the liquid crystal display device 1 is configured so that at a grayscale level, a difference (ΔVα) between (a) a voltage applied across a liquid crystal layer of a bright pixel and (b) a voltage applied across a liquid crystal layer of a dark pixel is different in a specific pixel. Specifically, the ΔVα in the B pixel 12 is made the smallest. It is possible to make ΔVα in the B pixel 12 smaller than each of (a) ΔVα in the R pixel 8 and (b) ΔVα in the G pixel 10, by making the capacitance of the auxiliary capacitor CsB of the B pixel 12 smaller than each of (i) the capacitance of the auxiliary capacitor CsR of the R pixel 8 and (ii) the capacitance of the auxiliary capacitor CsG of the G pixel 10. That is, the auxiliary capacitors are set to meet CsB<CsG≦CsR. It is possible to simplify the structure by employing a configuration where CsG=CsR.

The auxiliary capacitor Cs3B is formed in the bright pixel 12a of the B pixel 12. Note that Cs1R=Cs1G=Cs1B+Cs3B. In other words, the R pixel 8, the G pixel 10, and the B pixel 12 have identical total auxiliary capacitances in their respective bright pixels. Note, however, that the auxiliary capacitors connected to the common CS bus line 6n have their respective capacitances which meet Cs1B<Cs1R=Cs1G.

The auxiliary capacitor Cs4B is formed in the dark pixel 12b of the B pixel 12. Note that Cs2R=Cs2G=Cs2B+Cs4B. In other words, the R pixel 8, the G pixel 10, and the B pixel 12 have identical total auxiliary capacitances in their respective dark pixels. Note, however, that the auxiliary capacitors connected to common CS bus line 6(n+1) have their respective capacitances which meet Cs2B<Cs2R=Cs2G.

For example, the capacitances of the auxiliary capacitor CsR of the R pixel 8 and the auxiliary capacitor CsG of the G pixel 10 are therefore set to 150 fF, whilst the capacitance of the auxiliary capacitor CsB of the B pixel 12 is set to 60 fF. In this case, both Cs3B and Cs4B are set to 90 fF. Note that Vdata is 7.60 V, and the amplitude of the common voltage is set to 3 V.

A fixed voltage is applied across Cs3B through the CS bus line 7n. A fixed voltage is applied across Cs4B through the CS bus line 7(n+1). Therefore, Cs3B does not contribute to the voltage applied across the liquid crystal layer of the bright pixel, and Cs4B does not contribute to the voltage applied across the liquid crystal layer of the dark pixel.

The CS bus lines 7n and 6n are electrically isolated from each other. Similarly, the CS bus lines 7(n+1) and 6(n+1) are electrically isolated from each other. Note that the voltages applied to the respective CS bus lines 6n and 6(n+1) are rectangular pulse voltages with (i) identical amplitudes (peak-to-peak) of Vad, (ii) reversed phases (phase difference of) 180°, and (iii) duty ratio of 1:1.

Therefore, voltages of identical amplitudes are applied across the respective auxiliary capacitors Cs1R, Cs1G, and Cs1B through the common CS bus line 6n. The auxiliary capacitors affect the voltages applied across the liquid crystal layers in the respective bright pixels. In addition, voltages of identical amplitudes are applied across the respective auxiliary capacitors Cs2R, Cs2G, and Cs2B through the common CS bus line 6(n+1). The auxiliary capacitors affect the voltages applied across the liquid crystal layers in the respective dark pixels.

Recall that Cs1B<Cs1R=Cs1G and Cs2B<Cs2R=Cs2G. In other words, in the bright pixels and the dark pixels, the auxiliary capacitors (Cs1B, Cs2B) of the B pixel 12 are smaller than each of (i) the auxiliary capacitors (Cs1R, Cs2R) of the R pixel 8 and (ii) the auxiliary capacitors (Cs1G, Cs2G) of the G pixel 10. This allows Vα of the B pixel 12 to be made smaller than each of Vα of the R pixel 8 and Vα of the G pixel 10.

### (Amplitude Voltage ΔVd)

The foregoing amplitude voltage ΔVd is now described below in more detail. The liquid crystal display device 1 employing TFT1 and TFT2 typically has a characteristic in which there occurs drop, by an amplitude voltage ΔVd, in a voltage on each of the subpixel electrodes in response to a falling edge of a gate voltage Vg from VgH to VgL. Note that the amplitude voltage ΔVd depends on a ratio of (i) a capacitance of the parasitic capacitor Cgd formed between the gate and drain electrodes of the TFT element and (ii) capacitances of all the capacitors connected to the drain electrode (liquid crystal capacitor Clc, auxiliary capacitor Ccs, and other parasitic capacitors). Generally, auxiliary capacitors Cgd, Clc, and Ccs are dominant, and ΔVd=Cgd/(Clc+Ccs). Therefore, if only the auxiliary capacitor Ccs is simply changed as described above so that a desired ΔVα is obtained for each pixel, then ΔVd also differs from pixel to pixel. This causes an average voltage applied across the liquid crystal layer to vary from pixel to pixel. Under the circumstances, in a typical configuration where a single counter electrode is shared by all pixels, it is sometimes impossible that D.C. voltage components applied across the respective liquid crystal layers of all the pixels are reduced sufficiently even in a case where the counter voltage is adjusted. In a case where large D.C. voltage components are applied across the respective liquid crystal layers, a problem is caused that a display quality deteriorates.

The amplitude voltage ΔVd is determined by the sum of the capacitances of all the auxiliary capacitors formed in the pixels. Recall that in Embodiment 1, Cs1R=Cs1G=Cs1B+Cs3B and Cs2R=Cs2G=Cs2B+Cs4B. In other words, the auxiliary capacitors in the individual pixels have an equal total capacitance. Therefore, all the pixels have identical amplitude voltages ΔVd. As a result, the voltage difference, ΔVα, between the bright and dark pixels can be reduced only in the B pixel 12, while keeping the amplitude voltages ΔVd identical in the R pixel 8, the G pixel 10, and the B pixel 12.

(Observation from Oblique Direction)

FIG. 9 is a drawing showing grayscale level versus X, Y, and Z value characteristics obtained at the polar angle of 60° in the liquid crystal display device 1 in accordance with Embodiment 1. The liquid crystal display device 1 meets conditions in which a voltage (Vdata) supplied via the source bus lines is 7.60 V, each liquid crystal capacitance of the bright pixels 8a, 10a, and 12a and the dark pixels 8b, 10b, and 12b is 300 fF, the auxiliary capacitors CsR and CsG have respective capacitances of 150 fF, CsB has a capacitance of 60 fF, Cs3B and Cs4B each have a capacitance of 90 fF, and an amplitude of the common voltage is 3 V. Therefore, CsB<CsR=CsG. Note, however, that Cs1R=Cs1G=Cs1B+Cs3B and Cs2R=Cs2G=Cs2B+Cs4B.

### (X, Y, and Z Value Characteristics)

As is clear from FIG. 9, the grayscale level versus X, Y, and Z value characteristics have similar curve characteristics when the polar angle is 60°. In other words, according to the grayscale level versus Z value characteristic curve, the Z value is not below, but approximately equal to, the X and Y values, at intermediate grayscale levels. This is unlike the example shown in FIG. 4.

### (Chromaticity Characteristics)

FIG. 10 is a drawing showing grayscale level versus x-y value characteristics obtained at the polar angle of 60° in the liquid crystal display device 1 in accordance with Embodiment 1. In the example shown in FIG. 10, the x and y values are not irregular at intermediate grayscale levels 120 through 200. This is unlike the example shown in FIG. 5.

### (Local γ Characteristics)

FIG. 11 is a drawing showing grayscale level versus local γ characteristics obtained at the polar angle of 60° in the liquid crystal display device 1 in accordance with Embodiment 1. As is clear from the example shown in FIG. 11, a local γ of the X value, a local y of the Y value, and a local γ of the Z value have respective peaks at identical gray scales.

As is clear from FIGS. 9 through 11, the liquid crystal display device 1 in accordance with Embodiment 1 has no problem that a color shift occurs at an oblique viewing angle. The viewing angle characteristics have been thus improved.

### (Preferred Range of Capacitance of Auxiliary Capacitor CsB)

FIG. 12 is a drawing showing grayscale levels of respective pixels (red (R), green (G), and blue (B)) as to six (No. 19 through 24) out of 24 grayscale colors on the Macbeth chart. The values in FIG. 12 are design values in the case of two-degree field of view (C illuminant). FIG. 13 is a drawing showing a distance (Δu′v′) between coordinates of u′v′ chromaticity in a front direction and in an oblique direction (60° direction) when the six colors shown in FIG. 12 are displayed. The vertical axis represents Δu′v′, and the horizontal axis represents a ratio of (i) the capacitance of an auxiliary capacitor CsB of the B pixel 12 and (ii) the capacitance of an auxiliary capacitor CsG of the R pixel 8. In other words, in a case where CsG has a fixed capacitance, the CsB grows larger as the ratio represented by the horizontal axis increases.

As shown in FIG. 13, Δu′v′ is smaller when 0.2<(CsB/CsG)<0.7 than when CsB/CsG=1. The color shift is thus reduced when 0.2 <(CsB/CsG)<0.7, and therefore it is clear that the viewing angle characteristics can be improved.

### (Other Configurations)

In the liquid crystal display device 1, (i) the capacitance of either the auxiliary capacitor CsR of the R pixel 8 or the capacitance of the auxiliary capacitor CsG of the G pixel 10 can be substantially 0.50 times as large as the liquid crystal capacitance of the R pixel 8 or the liquid crystal capacitance of the G pixel 10 and (ii) the capacitance of the auxiliary capacitor CsB of the B pixel 12 can be substantially 0.20 times as large as the liquid crystal capacitance of the B pixel 12. These optimal values allow a further improvement in the viewing angle characteristics.

In the liquid crystal display device 1, it is preferable that 0.273≦ΔV12B/ΔV12G≦0.778, where ΔV12B indicates a difference between an effective voltage applied across the liquid crystal layer of the bright pixel 12a of the B pixel 12 and an effective voltage applied across the liquid crystal layer of the dark pixel 12b of the B pixel 12. ΔV12G indicates a difference between an effective voltage applied across the liquid crystal layer of the bright pixel 10a of the G pixel 10 and an effective voltage applied across the liquid crystal layer of the dark pixel 10b of the G pixel 10. In addition, ΔV12B/ΔV12G is most preferably 0.5. These optimal values allow a further improvement in the viewing angle characteristics.

In the liquid crystal display device 1, 8a, 10a, and 12a are bright pixels, and 8b, 10b, and 12b are dark pixels. Embodiment 1 is, however, not limited to this. Alternatively, it is possible to reverse concurrently (i) the phase of a voltage applied to the CS bus line 6n and (ii) the phase of a voltage applied to the CS bus line 6(n+1) , which phases are those shown in FIG. 2, so that 8a, 10a, and 12a a serve as dark pixels, and 8b, 10b, and 12b serve as dark pixels.

In the liquid crystal display device 1, in each pixel, the capacitance of the auxiliary capacitor in a corresponding bright pixel is equal to the capacitance of the auxiliary capacitor in a corresponding dark pixel. Embodiment 1 is, however, not limited to this. Alternatively, only capacitances of the auxiliary capacitors in the respective bright pixels 8a, 10a, and 12a can be different from pixel to pixel. Alternatively, only capacitances of the auxiliary capacitors in the respective dark pixels 8b, 10b, and 12b can differ from pixel to pixel. Alternatively, the auxiliary capacitors of the bright pixels 8a, 10a, and 12a in the respective pixels can have identical capacitances. Alternatively, the auxiliary capacitors of the dark pixels 8b, 10b, and 12b in the respective pixels can have identical capacitances. This allows the bright pixels 8a, 10a, and 12a or the dark pixels 8b, 10b, and 12b to be more simply configured.

In order to improve the viewing angle characteristics, the liquid crystal display device 1 can employ a technology which causes the R, G, and B pixels to have respective different cell gaps i.e., respective different thicknesses. In other words, the viewing angle characteristics can be improved by applying to the present invention a well known technology which causes the R, G, and B pixels to have respective different cell gaps.

### (Modification)

FIG. 14 is a drawing showing a liquid crystal display device 1a which is configured so that auxiliary capacitors Cs3B and Cs4B are connected to a common CS bus line 7n. According to the liquid crystal display device 1a shown in FIG. 14, the auxiliary capacitors Cs3B and Cs4B are connected to the common CS bus line 7n, unlike the liquid crystal display device 1 shown in FIG. 1. This causes a common fixed voltage to be applied to the auxiliary capacitors Cs3B and Cs4B. The liquid crystal display device la brings about effects similar to those brought about by the liquid crystal display device 1.

### Embodiment 2

The following description will discuss Embodiment 2 in accordance with the present invention in reference to FIGS. 15 through 22. The members of Embodiment 2 that have the same arrangements and functions as the members of Embodiment 1 are indicated by the respective same reference numerals and their respective detailed descriptions are omitted.

FIG. 15 is a drawing showing an equivalent circuit of a pixel in a liquid crystal display device 1b in accordance with Embodiment 2. According to the liquid crystal display device 1b, an auxiliary capacitor Cs1R (first auxiliary capacitor) and an auxiliary capacitor Cs1G (first auxiliary capacitor) are connected to a CS bus line 6n, whilst an auxiliary capacitor Cs1B (first auxiliary capacitor) is connected to a CS bus line 7n, not to the CS bus line 6n (see FIG. 15). Similarly, an auxiliary capacitor Cs2R (second auxiliary capacitor) and an auxiliary capacitor Cs2G (second auxiliary capacitor) are connected to a CS bus line 6(n+1), whilst an auxiliary capacitor Cs2B (second auxiliary capacitor) is connected to a CS bus line 7(n+1), not to the CS bus line 6(n+1). It should be noted that the liquid crystal display device 1b includes no auxiliary capacitors Cs3B and Cs4B.

The CS bus line 7n is electrically isolated from the CS bus line 6n. Similarly, the CS bus line 7(n+1) is electrically isolated from the CS bus line 6(n+1). This allows (i) the auxiliary capacitors Cs1R, Cs1G, and Cs1B to be designed to have identical capacitances and (ii) a voltage applied across the auxiliary capacitors Cs1R and Cs1G through the CS bus line 6n to have an amplitude different from that of a voltage applied across the auxiliary capacitor Cs1B through the CS bus line 7n. Specifically, the latter is made smaller than the former. Similarly, the auxiliary capacitors Cs2R, Cs2G, and Cs2B can be designed to have identical capacitances, and a voltage applied across the auxiliary capacitors Cs2R and Cs2G through the CS bus line 6(n+1) can be designed to have an amplitude different from that of the voltage applied across the auxiliary capacitors Cs2B through the CS bus line 7(n+1). Specifically, the latter is made smaller than the former.

Note that the waveforms of the voltage applied to the CS bus line 6n and the voltage applied to the CS bus line 6(n+1) are rectangular pulse voltages with (i) identical amplitudes (peak-to-peak) of Vad (first amplitude, third amplitude), (ii) reversed phases (phase difference of 180°), and (iii) duty ratio of 1:1. The waveforms of the voltage applied to the CS bus line 7n and the voltage applied to the CS bus line 7(n+1) are rectangular pulse voltages with (i) identical amplitudes (peak-to-peak) of Vad′ (second amplitude, fourth amplitude) which is smaller than Vad, (ii) reversed phases (phase difference of 180°), and (iii) duty ratio of 1:1.

As a result, Vα of the B pixel 12 can be made smaller than each Vα of the R pixel 8 and the G pixel 10.

### (Viewing Angle Characteristics of Comparative Example)

The following description will first discuss a problem that a color shift occurs at an oblique viewing angle in a comparative example of the liquid crystal display device 1b. The liquid crystal display device 1b of the comparative example meets conditions in which the voltage (Vdata) supplied via the source bus lines 4 is 7.60 V, each liquid crystal capacitance of the bright pixels 8a, 10a, and 12a and the dark pixels 8b, 10b, and 12b is 300 fF, the auxiliary capacitors CsR, CsG, and CsB have respective capacitances of 150 fF, an amplitude of the common voltage is 3 V, an amplitude of the voltage applied through the CS bus lines 6 is 3 V, and an amplitude of the voltage applied through the CS bus lines 7 is 3 V.

In a case where an amplitude of a voltage applied across Cs1G (Cs1B) is VCsG and an amplitude of a voltage applied across Cs1B is VCsB, VCsG=VCsB.

### (X, Y, and Z Value Characteristics)

FIG. 16 is a drawing showing grayscale level versus X, Y, and Z value characteristics obtained at a polar angle of 60° in the liquid crystal display device 1b in accordance with a comparative example. As shown in FIG. 16, in a case where a polar angle is 60°, the grayscale level versus X value curve is similar to the grayscale level versus Y value curve. However, the grayscale level versus Z value curve, especially at an intermediate grayscale level, is below the X and Y value curves. Since the Z value is color stimulus primarily representing blue as described earlier, in a case where a particular color is to be displayed at an intermediate grayscale level, a blue color which is lighter than the blue corresponding to an intended grayscale level is displayed at the 60° polar angle. Specifically, since a blue component of an image to be displayed decreases, the image looks like a yellowish one. This leads to a deterioration in color tone of viewing angle characteristic.

### (Chromaticity Characteristics)

FIG. 17 is a drawing showing grayscale level versus x-y value characteristics obtained at the polar angle of 60° in the liquid crystal display device lb in accordance with a comparative example. As shown in FIG. 17, each of x and y values exhibits a degree, of a change in chromaticity to a change in grayscale level, which occurs at an intermediate grayscale level (ranging from a grayscale level 120 to a grayscale level 200), deviates from a degree, of a change in chromaticity to a change in grayscale level, which occurs at another gray scale level. As is also clear from FIG. 17, a color shift occurs.

### (Local γ Characteristics)

FIG. 18 is a drawing showing grayscale level versus local γ characteristics obtained at the polar angle of 60° in the liquid crystal display device lb in accordance with a comparative example. As shown in FIG. 18, a local γ of the X value and a local γ of the Y value have respective peaks at identical gray scales, specifically, at around grayscale level 140. In contrast, the peak of the local y of the Z value deviates from these two peaks and located, specifically, at around grayscale level 170. Since the peak of the local γ of the Z value thus deviates from those of the X and Y values, an image to be displayed becomes yellowish at about an intermediate grayscale level in a case where the display screen is viewed from an oblique direction.

### (Viewing Angle Characteristics of the Embodiment 2)

The following description will discuss that color shift problems can be prevented from occurring at an oblique viewing angle in the liquid crystal display device 1b in accordance with Embodiment 2. The liquid crystal display device lb in accordance with Embodiment 2 meets conditions in which the voltage (Vdata) supplied via the source bus lines 4 is 7.60 V, each liquid crystal capacitance of the bright pixels 8a, 10a, and 12a and the dark pixels 8b, 10b, and 12b is 300 fF, the auxiliary capacitors CsR, CsG, and CsB have respective capacitances of 150 fF, an amplitude of the common voltage is 3 V, an amplitude of the voltage applied through the CS bus lines 6 is 3 V, and an amplitude of the voltage applied through the CS bus lines 7 is 1.5 V. Therefore, VCsG>VCsB. More specifically, VCsB/VCsG=0.5.

### (X, Y, and Z Value Characteristics)

FIG. 19 is a drawing showing grayscale level versus X, Y, and Z value characteristics obtained at the polar angle of 60° in the liquid crystal display device lb in accordance with Embodiment 2. As shown in this figure, when the polar angle is 60°, the grayscale level versus X, Y, and Z value characteristics have similar curve characteristics. In other words, according to the grayscale level versus Z value characteristic curve, the Z value is not below, but approximately equal to, the X and Y values, at intermediate grayscale levels. This is unlike the example shown in FIG. 16.

### (Chromaticity Characteristics)

FIG. 20 is a drawing showing grayscale level versus x-y value characteristics obtained at the polar angle of 60° in the liquid crystal display device 1b in accordance with Embodiment 2. In the example shown in FIG. 20, the x and y values are not irregular at intermediate grayscale levels 120 through 200. This is unlike the example shown in FIG. 17.

### (Local γ Characteristics)

FIG. 21 is a drawing showing grayscale level versus local γ characteristics obtained at the polar angle of 60° in the liquid crystal display device lb in accordance with Embodiment 2. As is clear from in FIG. 21, a local γ of the X value, a local γ of the Y value, and a local γ of the Z value have respective peaks at identical gray scales.

As is clear from FIGS. 19 through 21, in the liquid crystal display device 1b in accordance with Embodiment 2 has no problem that a color shift occurs at an oblique viewing angle. The viewing angle characteristics have been thus improved.

### (Preferred Range of VCsB/VCsG)

The value of VCsB/VCsG is preferably greater than 0.3 and smaller than 1.0 for the reasons described below in reference to FIG. 22.

FIG. 22 is a drawing showing a distance (Δv′v′) between coordinates of u′v′ chromaticity in a front direction and in an oblique direction (60° direction) when the six colors shown in FIG. 12 are displayed on the liquid crystal display device 1 in accordance with Embodiment 2. The vertical axis represents Δu′v′, and the horizontal axis represents VCsB/VCsG. In other words, provided that CsG has a fixed capacitance, the VCsB grows larger as the ratio represented by the horizontal axis increases.

As shown in FIG. 20, the value of Δu′v′ is smaller when 0.3<(VCsB/VCsG)<1.0 than when VCsB/VCsG=1. The color shift is thus reduced when 0.3<(VCsB/VCsG)<1.0, and therefore it is clear that the viewing angle characteristics can be improved because color shift can be reduced in that range.

In the foregoing example, none of the auxiliary capacitors of the B pixel 12 are connected to the CS bus line 6n. An auxiliary capacitor for the B pixel 12 may be formed separately along the CS bus line 6n.

### (Other Configurations)

In the liquid crystal display device 1b, it is preferable that 0.273≦ΔV12B/ΔV12G≦0.778, where ΔV12B indicates a difference between an effective voltage applied across the liquid crystal layer of the bright pixel 12a of the B pixel 12 and an effective voltage applied across the liquid crystal layer of the dark pixel 12b of the B pixel 12. ΔV12G indicates a difference between an effective voltage applied across the liquid crystal layer of the bright pixel 10a of the G pixel 10 and an effective voltage applied across the liquid crystal layer of the dark pixel 10b of the G pixel 10. In addition, ΔV12B/ΔV12G is most preferably 0.5. These optimal values allow a further improvement in the viewing angle characteristics.

In the liquid crystal display device 1b, 8a, 10a, and 12a are bright pixels, and 8b, 10b, and 12b are dark pixels. Embodiment 2 is, however, not limited to this. Alternatively, it is possible to reverse concurrently (i) the phase of a voltage applied to the CS bus line 6n and (ii) the phase of a voltage applied to the CS bus line 6(n+1) , which phases are those shown in FIG. 2, so that 8a, 10a, and 12a serve as dark pixels, and 8b, 10b, and 12b serve as dark pixels.

To improve the viewing angle characteristics, the liquid crystal display device 1b can employ a technology which causes the R, G, and B pixels to have respective different cell gaps i.e., respective different liquid crystal thicknesses. In other words, the viewing angle characteristics can be improved by applying to the present invention a well known technology which causes the R, G, and B pixels to have respective different cell gaps.

### (Supplementary Notes)

The present invention is by no means limited to foregoing Embodiments 1 and 2 and can be varied in many ways without departing from the scope defined in the claims. In other words, the present invention encompasses in its scope any embodiments obtained by combining technical means varied appropriately without departing from the scope of the claims.

The present invention can be delineated, for example, as follows.

1. An MPD liquid crystal display device has different R, G, and B CS capacitances.

2. Especially, a liquid crystal display device wherein the B CS capacitance is smaller than the R and G CS capacitances (the B CS capacitance is 0.40 times as large as the R and G CS capacitances).

3. A liquid crystal display device wherein the R and G CS capacitances are 0.50 times as large as the liquid crystal capacitance (when Von is being applied), and only the B CS capacitance is 0.20 times as large as the liquid crystal capacitance.

4. A liquid crystal display device wherein the voltage difference between the subpixels when Von is being applied for B (0.5 V) is 0.50 times as large as that for R and G (1 V).

5. A liquid crystal display device wherein only either the bright or dark pixels in the pixels of each color have different CS capacitances.

6. A liquid crystal display device has different cell gaps for R, G, and B (however, the foregoing CS and ratio of voltage differences are different).

7. A liquid crystal display device in which the R and G pixel are connected to a different CS line from a CS line to which the B pixel is connected, and amplitude is varied.

The liquid crystal display device in accordance with the present invention is, preferably, such that:

a third auxiliary capacitor is further connected to a first subpixel constituting the pixel displaying blue;

a first auxiliary capacitor line is connected also to the third auxiliary capacitor; and

the third auxiliary capacitor in a pixel displaying blue has a capacitance which is smaller than that of the first auxiliary capacitor in the pixel displaying red or green;

the liquid crystal display device further comprising:

an auxiliary capacitor driver for applying (i) a voltage having a predefined amplitude via the first auxiliary capacitor line and (ii) a fixed voltage via the second auxiliary capacitor line.

According to the above arrangement, a fixed voltage is applied across a first auxiliary capacitor in the blue pixel. This auxiliary capacitor thus does not affect the difference between the voltages applied across the subpixels in the blue pixel. In contrast, an amplitude voltage is applied across the third auxiliary capacitor in the blue pixel. This auxiliary capacitor thus affects the difference between the voltages applied across the subpixels in the blue pixel. In addition, a fixed voltage is applied across a first auxiliary capacitor in the red or green pixel. This auxiliary capacitor thus affects the difference between the voltages applied across the subpixels in the red or green pixel.

A voltage with the identical amplitude is applied across a first auxiliary capacitor in the red or green pixel and to the third auxiliary capacitor in the blue pixel. The capacitance of the third auxiliary capacitor in the blue pixel is smaller than the capacitance of the first auxiliary capacitor in the red or green pixel. Accordingly, at a certain grayscale level, the difference between the voltages applied across the subpixels in the blue pixel is smaller than the difference between the voltages applied across the subpixels in the red or green pixel.

As a result, in a voltage range with its minimum and maximum grayscale levels having been specified, the voltage range in which only the bright pixel is lighted (the dark pixel is not lighted yet) in the blue pixel can be made narrower than the voltage range in which only the bright pixel is lighted in the red or green pixel. Therefore, the ratio, over the entire grayscale level range, of the grayscale level range in which only the bright pixel is lighted and the grayscale level range in which both the bright and dark pixels are lighted can be made substantially equal, regardless of the primary color of the pixel. This can reduce the color shift occurrence when the screen is viewed from the oblique direction.

In the liquid crystal display device in accordance with the present invention, furthermore, preferably, a difference between a voltage applied across the first subpixel in the pixel displaying blue and a voltage applied across the second subpixel in the pixel displaying blue is 0.273 or more times and 0.778 or less times as large as a difference between a voltage applied across the first subpixel in the pixel displaying red or green and a voltage applied across the second subpixel in the pixel displaying red or green.

According to the above arrangement, the color shift at an oblique viewing angle can be suitably reduced.

In the liquid crystal display device in accordance with the present invention, furthermore, preferably, the third auxiliary capacitor in a pixel displaying blue has a capacitance which is more than 0.20 times and less than 0.70 times as large as that of the first auxiliary capacitor in the pixel displaying red or green.

According to the above arrangement, the color shift at an oblique viewing angle can be suitably reduced.

In the liquid crystal display device in accordance with the present invention, furthermore, preferably, the difference between a voltage applied across the first subpixel in the pixel displaying blue and a voltage applied across the second subpixel in the pixel displaying blue is substantially 0.50 times as large as the difference between a voltage applied across the first subpixel in the pixel displaying red or green and a voltage applied across the second subpixel in the pixel displaying red or green.

According to the above arrangement, the color shift at an oblique viewing angle can be optimally reduced.

In the liquid crystal display device in accordance with the present invention, furthermore, preferably, the first auxiliary capacitor in the pixel displaying red or green has a capacitance which is substantially 0.50 times as large as a liquid crystal capacitance of the first subpixel in the pixel; and the third auxiliary capacitor in a pixel displaying blue has a capacitance which is substantially 0.20 times as large as a liquid crystal capacitance of the first subpixel in the pixel.

According to the above arrangement, the color shift at an oblique viewing angle can be optimally reduced.

In the liquid crystal display device in accordance with the present invention, furthermore, preferably, the second subpixel, constituting the pixel displaying blue, is further connected to a fourth auxiliary capacitor; the fourth auxiliary capacitor in a pixel displaying blue has a capacitance which is smaller than that of the second auxiliary capacitor in the pixel displaying red or green;

the liquid crystal display device further comprising

a third auxiliary capacitor line connected commonly to a first auxiliary capacitor in a pixel displaying red, the first auxiliary capacitor in a pixel displaying green, and the fourth auxiliary capacitor; and

a fourth auxiliary capacitor line connected to the second auxiliary capacitor in a pixel displaying blue, the fourth auxiliary capacitor line being electrically isolated from the third auxiliary capacitor line,

the auxiliary capacitor driver applying (i) a voltage having a predefined amplitude via the third auxiliary capacitor line and (ii) a fixed voltage via the fourth auxiliary capacitor line.

According to the above arrangement, the difference between the voltages applied across the subpixels in the blue pixel can be more freely controlled.

The liquid crystal display device in accordance with the present invention as set forth in any one of claims 2 through 7, is such that: the second subpixel, constituting the pixel displaying blue, further includes a fourth auxiliary capacitor; the fourth auxiliary capacitor in the pixel displaying blue has a capacitance which is smaller than that of the second auxiliary capacitor in the pixel displaying red or green,

the liquid crystal display device further comprising a third auxiliary capacitor line connected commonly to the second auxiliary capacitor in the pixel displaying red, the second auxiliary capacitor in the pixel displaying green, and the fourth auxiliary capacitor,

the second auxiliary capacitor line being further connected to the second auxiliary capacitor in the pixel displaying blue,

the auxiliary capacitor driver applying a voltage having a predefined amplitude via the third auxiliary capacitor line.

According to the above arrangement, the difference between the voltages applied across the subpixels in the blue pixel can be more freely controlled.

In the liquid crystal display device in accordance with the present invention, furthermore, preferably, the second auxiliary capacitor in the pixel displaying any one of the primary colors has a capacitance which is equal to that of the second auxiliary capacitor in the pixel displaying another one of the primary colors.

According to the above arrangement, the pixel structure is simplified, as well as, the color shift at an oblique viewing angle can be reduced.

In the liquid crystal display device in accordance with the present invention, furthermore, preferably, the first auxiliary capacitors have identical capacitances, regardless of which primary colors the respective pixels display,

the liquid crystal display device further comprising

an auxiliary capacitor driver for applying (i) a voltage having a predefined amplitude via the first auxiliary capacitor line and (ii) a voltage having a smaller amplitude than the predefined amplitude via the second auxiliary capacitor line.

According to the above arrangement, the first auxiliary capacitors have identical capacitances, regardless of which primary colors the respective pixels display, whilst the amplitude of the voltage applied across the first auxiliary capacitor in the blue pixel is smaller than the amplitude of the voltage applied across the first auxiliary capacitor in the red or green pixel. Therefore, the difference between the voltages applied across the subpixels in the blue pixel is smaller than the difference between the voltages applied across the subpixels in the red or green pixel.

Over the entire grayscale level range covering from a minimum grayscale level to a maximum grayscale level, the grayscale level range in which only the bright pixel is lighted (the dark pixel is not lighted yet) in the blue pixel can be made narrower than the grayscale level range in which only the bright pixel is lighted in the red or green pixel. Therefore, the ratio, over the entire grayscale level range, of the grayscale level range allocated to the bright pixel and the grayscale level range allocated to the dark pixel can be made substantially equal regardless of the primary color of the pixel. This can reduce the color shift occurrence when the screen is viewed from the oblique direction.

In the liquid crystal display device in accordance with the present invention, furthermore, preferably, a ratio of the second amplitude to the first amplitude is greater than 0.3 and smaller than 1.0.

According to the above arrangement, the color shift at an oblique viewing angle can be suitably reduced.

In the liquid crystal display device in accordance with the present invention, furthermore, preferably, the second auxiliary capacitors have identical capacitances, regardless of which primary colors the respective pixels display; the liquid crystal display device further comprising:

a third auxiliary capacitor line connected commonly to the second auxiliary capacitor in the pixel displaying red and the second auxiliary capacitor in the pixel displaying green; and

a fourth auxiliary capacitor line connected to the second auxiliary capacitor in the pixel displaying blue,

the auxiliary capacitor driver applying (i) a voltage having a predefined third amplitude via the third auxiliary capacitor line and (ii) a voltage having a fourth amplitude which differs from the third amplitude via the fourth auxiliary capacitor line.

According to the above arrangement, the difference between the voltages applied across the subpixels in the blue pixel can be more freely controlled.

In the liquid crystal display device in accordance with the present invention, furthermore, preferably, the first subpixel has, at a certain grayscale level, a lower luminance than the second subpixel.

According to the above arrangement, the first subpixel can be used as a dark pixel, and the second subpixel can be used as a bright pixel.

In the liquid crystal display device in accordance with the present invention, furthermore, preferably, the first subpixel has, at a certain grayscale level, a higher luminance than the second subpixel.

According to the above arrangement, the first subpixel can be used as a bright pixel, and the second subpixel can be used as a dark pixel.

The embodiments and concrete examples of implementation discussed in the foregoing detailed description serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The liquid crystal display device of the present invention is widely useable as various liquid crystal display devices of, for example, VA mode.

### REFERENCE SIGNS LIST

1 Liquid Crystal Display Device

1a Liquid Crystal Display Device

1b Liquid Crystal Display Device

2 Gate Bus line

4 Source Bus Line

6n CS bus line (First auxiliary capacitor Line)

6(n+1) CS bus line (Third auxiliary capacitor Line)

7n CS Bus Line Exclusively for B Pixel 12 (second auxiliary capacitor line)

7(n+1) CS Bus Line Exclusively for B Pixel 12 (Fourth Auxiliary Capacitor Line)

8 Pixel

8a Bright Pixel (First Subpixel) in R Pixel 8b Dark Pixel (Second Subpixel) in R Pixel

10 G Pixel

10a Bright Pixel (First Subpixel) in G pixel

10b Dark Pixel (Second Subpixel) in G pixel

12 B Pixel

12a Bright Pixel (First Subpixel) in B pixel

12b Dark Pixel (Second Subpixel) in B pixel

Cs1R Auxiliary Capacitor (First auxiliary capacitor)

Cs1G Auxiliary Capacitor (First auxiliary capacitor)

Cs1B Auxiliary Capacitor (First auxiliary capacitor, Third auxiliary capacitor)

Cs2R Auxiliary Capacitor (Second auxiliary capacitor)

Cs2G Auxiliary Capacitor (Second auxiliary capacitor)

Cs2B Auxiliary Capacitor (Second auxiliary capacitor, Fourth Auxiliary Capacitor)

Cs3B Auxiliary Capacitor (First auxiliary capacitor)

Cs4B Auxiliary Capacitor (Second auxiliary capacitor)

1. A liquid crystal display device, employing multipixel drive, comprising:
a plurality of pixels each displaying any one of mutually different primary colors;
a first subpixel, provided for each of the plurality of pixels, which has a first auxiliary capacitor;
a second subpixel, provided for each of the plurality of pixels, which has a second auxiliary capacitor, the second subpixel having, at a certain grayscale level, a different luminance from that of the first subpixel;
a first auxiliary capacitor line connected commonly to a first auxiliary capacitor in a pixel displaying red and to a first auxiliary capacitor in a pixel displaying green; and
a second auxiliary capacitor line connected to at least a first auxiliary capacitor in a pixel displaying blue, the second auxiliary capacitor line being electrically isolated from the first auxiliary capacitor line.

2. The liquid crystal display device as set forth in claim 1, wherein:
a first subpixel, constituting the pixel displaying blue, further includes a third auxiliary capacitor;
the first auxiliary capacitor line is also connected to the third auxiliary capacitor; and
the third auxiliary capacitor in the pixel displaying blue has a capacitance which is smaller than that of the first auxiliary capacitor in the pixel displaying red or green,
said liquid crystal display device further comprising:
an auxiliary capacitor driver for applying (i) a voltage having a predefined amplitude via the first auxiliary capacitor line and (ii) a fixed voltage via the second auxiliary capacitor line.

3. The liquid crystal display device as set forth in claim 2, wherein
a difference between a voltage applied across the first subpixel in the pixel displaying blue and a voltage applied across the second subpixel in the pixel displaying blue is 0.273 or more times and 0.778 or less times as large as a difference between a voltage applied across the first subpixel in the pixel displaying red or green and a voltage applied across the second subpixel in the pixel displaying red or green.

4. The liquid crystal display device as set forth in claim 2, wherein
the third auxiliary capacitor in the pixel displaying blue has a capacitance which is more than 0.20 times and less than 0.70 times as large as that of the first auxiliary capacitor in the pixel displaying red or green.

5. The liquid crystal display device as set forth in claim 3, wherein
the difference between a voltage applied across the first subpixel in the pixel displaying blue and a voltage applied across the second subpixel in the pixel displaying blue is substantially 0.50 times as large as the difference between a voltage applied across the first subpixel in the pixel displaying red or green and a voltage applied across the second subpixel in the pixel displaying red or green.

6. The liquid crystal display device as set forth in claim 2, wherein:
the first auxiliary capacitor in the pixel displaying red or green has a capacitance which is substantially 0.50 times as large as a liquid crystal capacitance of the first subpixel in the pixel; and
the third auxiliary capacitor in the pixel displaying blue has a capacitance which is substantially 0.20 times as large as a liquid crystal capacitance of the first subpixel in the pixel.

7. The liquid crystal display device as set forth in claim 2, wherein:
the second subpixel constituting the pixel displaying blue further includes a fourth auxiliary capacitor; and
the fourth auxiliary capacitor in the pixel displaying blue has a capacitance which is smaller than that of the second auxiliary capacitor in the pixel displaying red or green,
said liquid crystal display device further comprising:
a third auxiliary capacitor line connected commonly to the second auxiliary capacitor in the pixel displaying red, the second auxiliary capacitor in the pixel displaying green, and the fourth auxiliary capacitor; and
a fourth auxiliary capacitor line connected to at least the second auxiliary capacitor in the pixel displaying blue, the fourth auxiliary capacitor line being electrically isolated from the third auxiliary capacitor line,
the auxiliary capacitor driver applying (i) a voltage having a predefined amplitude via the third auxiliary capacitor line and (ii) a fixed voltage via the fourth auxiliary capacitor line.

8. The liquid crystal display device as set forth in claim 2, wherein:
the second subpixel constituting the pixel displaying blue further includes a fourth auxiliary capacitor; and
the fourth auxiliary capacitor in the pixel displaying blue has a capacitance which is smaller than that of the second auxiliary capacitor in the pixel displaying red or green,
said liquid crystal display device further comprising a third auxiliary capacitor line connected commonly to the second auxiliary capacitor in the pixel displaying red, the second auxiliary capacitor in the pixel displaying green, and the fourth auxiliary capacitor,
the second auxiliary capacitor line being further connected to the second auxiliary capacitor in the pixel displaying blue,
the auxiliary capacitor driver applying a voltage having a predefined amplitude via the third auxiliary capacitor line.

9. The liquid crystal display device as set forth in claim 4, wherein
the second auxiliary capacitor in the pixel displaying any one of the primary colors has a capacitance which is equal to that of the second auxiliary capacitor in the pixel displaying another one of the primary colors.

10. The liquid crystal display device as set forth in claim 1, wherein:
the first auxiliary capacitors have identical capacitances, regardless of which primary colors the respective pixels display,
said liquid crystal display device further comprising:
an auxiliary capacitor driver for applying (i) a voltage having a predefined first amplitude via the first auxiliary capacitor line and (ii) a voltage having a second amplitude which differs from the first amplitude via the second auxiliary capacitor line.

11. The liquid crystal display device as set forth in claim 10, wherein
a ratio of the second amplitude to the first amplitude is greater than 0.3 and smaller than 1.0.

12. The liquid crystal display device as set forth in claim 10, wherein
the second auxiliary capacitors have identical capacitances, regardless of which primary colors the respective pixels display;
said liquid crystal display device further comprising:
a third auxiliary capacitor line connected commonly to the second auxiliary capacitor in the pixel displaying red and the second auxiliary capacitor in the pixel displaying green; and
a fourth auxiliary capacitor line connected to the second auxiliary capacitor in the pixel displaying blue,
the auxiliary capacitor driver applying (i) a voltage having a predefined third amplitude via the third auxiliary capacitor line and (ii) a voltage having a fourth amplitude which differs from the third amplitude via the fourth auxiliary capacitor line.

13. The liquid crystal display device as set forth in claim 2, wherein
the first subpixel has, at a certain grayscale level, a lower luminance than the second subpixel.

14. The liquid crystal display device as set forth in claim 2, wherein
the first subpixel has, at a certain grayscale level, a higher luminance than the second subpixel.
